(19) United States
(12) Patent Application Publication
(10) Pub. No.: US 2017/0200345 A1
(43) Pub. Date: Jul. 13, 2017

(54) GAMING MACHINE

(71) Applicants: Universal Entertainment Corporation, Tokyo (JP); Aruze Gaming (Hong Kong) Limited, Kowloon (HK)

(72) Inventors: Masumi FUJISAWA, Tokyo (JP); Yukinori Inamura, Tokyo (JP); Kenta Kitamura, Tokyo (JP)

(21) Appl. No.: 15/393,394

(22) Filed: Dec. 29, 2016

(30) Foreign Application Priority Data
Jan. 13, 2016 (JP) 2016-004600
Jan. 13, 2016 (JP) 2016-004681

(51) Int. Cl. G07F 17/32; G07F 17/34

(52) U.S. Cl. CPC G07F 17/3213; G07F 17/3225; G07F 17/3244; G07F 17/34

(57) ABSTRACT

A gaming machine which makes it possible to avoid monotonous game play is provided. A gaming machine executes: (1A) a symbol random determination process of randomly selecting a symbol to be rearranged from symbols on a predetermined reel, based on a predetermined symbol random determination table; (1B) a process of selecting one of the symbol random determination tables, with reference to the symbol selected in the symbol random determination process and the symbol random determination table selection table; and (1C) a symbol random determination process of randomly selecting a symbol to be rearranged from symbols on a reel which is to be rearranged after the predetermined reel, based on the symbol random determination table selected in the process (1B).

### CROSS-REFERENCE TO RELATED APPLICATION

This application claims the benefit of Japanese Pat. App. No. 2016-004600, filed on Jan. 13, 2016 and Japanese Pat. App. No. 2016-004681, filed on Jan. 13, 2016 which applications are each incorporated herein by reference in its entirety.

### FIELD OF THE INVENTION

As a typical gaming machine, a slot machine is arranged such that, as a player presses a button on a control panel, reels on which symbols are provided are scrolled and then stopped, with the result that the symbols are rearranged. In such a slot machine, a benefit such as a payout is awarded to a player based on a combination of rearranged symbols.

### BACKGROUND OF THE INVENTION

A type of the slot machines is arranged such that, after each reel is rotated and stopped, symbols are rearranged at equal probabilities. For example, when 22 symbols are arranged on a reel, a probability of rearrangement of each of 22 symbols is 1/22. In the meanwhile, another type of the slot machines is arranged such that, after each reel is scrolled and stopped, symbols are rearranged at not equal but different probabilities. In such a slot machine, for example, when 22 symbols are arranged on a reel, a probability of rearrangement of each symbol is different between the symbols, e.g., a probability of rearrangement of a symbol A is 1/10 whereas a probability of rearrangement of a symbol B is 1/50, and a random determination table in which a probability of rearrangement is associated with each symbol is provided (see Patent Literature 1 (Japanese Unexamined Patent Publication No. 2013-153875)).

### BRIEF SUMMARY OF THE INVENTION

In the slot machine above, the random determination table in which a probability of rearrangement is associated with symbols of each reel is typically identical between games, with the result that game play may be monotonous.

An object of the present invention is to provide a gaming machine which makes it possible to avoid monotonous game play.

The present invention relates to a gaming machine including: a display device configured to display a game result by rearranging reels on which symbols are arranged;

a storage device configured to store symbol random determination tables in which the probabilities of rearrangement of a predetermined symbol are differentiated between reels by defining the probability of rearrangement of each symbol and a symbol random determination table selection table in which combinations of rearranged symbols are associated with the symbol random determination tables; and
a controller programmed to execute:
(1A) a symbol random determination process of randomly selecting a symbol to be rearranged from symbols on a predetermined reel, based on a predetermined symbol random determination table;
(1B) a process of selecting one of the symbol random determination tables, with reference to the symbol selected in the symbol random determination process and the symbol random determination table selection table; and
(1C) a symbol random determination process of randomly selecting a symbol to be rearranged from symbols on a reel which is to be rearranged after the predetermined reel, based on the symbol random determination table selected in the process (1B).

According to the arrangement above, a symbol random determination table, which is referred to when a symbol to be rearranged is selected from symbols on a reel to be rearranged next, is selected based on a symbol rearranged on a predetermined reel. As such, the probability of rearrangement of each symbol in a reel which is to be rearrangement after a predetermined reel is determined based on a symbol rearranged on the predetermined reel. With this arrangement, the probability of rearrangement of a predetermined symbol on the display is changed in accordance with the game progress, with the result that monotonousness in the game play is resolved.

In addition to the above, the above-described gaming machine of the present invention is arranged such that

the controller is configured to further execute:
(1D) a process of repeating the processes (1B) and (1C) until symbols to be rearranged on all reels are determined; and
(1E) a process of displaying the symbols to be rearranged on each of the reels on the display device, by rearranging the reels.

According to the arrangement above, the probabilities of rearrangement of symbols on all reels are determined based on the symbols on the reel rearranged in the directly preceding step. With this, the probabilities of rearrangement of all symbols on the display device is changed in accordance with the game progress, with the result that monotonousness in the game play is resolved.

In the present invention, the above-described gaming machine is arranged such that in the symbol random determination table selection table, a symbol random determination table corresponding to the predetermined symbol is arranged so that the probability of rearrangement of the predetermined symbol is higher than the probability of rearrangement of the predetermined symbol in a symbol random determination table corresponding to another symbol.

According to the arrangement above, when a symbol rearranged on a predetermined reel is a predetermined symbol, the probability of rearrangement of the predetermined symbol on a reel which is to be rearranged after the predetermined reel is arranged to be high. With this, when a symbol rearranged on a predetermined reel is a predetermined symbol, the probability of rearrangement of the predetermined symbol on a reel which is to be rearranged after the predetermined reel is high, with the result that the overall probability of rearrangement of the predetermined symbol on the display device is increased and the monotony in the game is resolved.

In the present invention, the above-described gaming machine is arranged such that when the predetermined symbol is selected as a symbol to be rearranged in the symbol random determination process (1A), the symbol random determination table selection table in which the probability of rearrangement of the predetermined symbol in the symbol random determination table corresponding to the predetermined symbol is higher than the probability of rearrangement of the predetermined symbol in a symbol random determination table corresponding to another symbol is referred to in the process (1B).

According to the arrangement above, when a symbol rearranged on the first reel is a predetermined symbol, the probability of rearrangement of the predetermined symbol on the second reed to be rearranged is arranged to be high.

The present invention relates to a gaming machine including: a display device configured to display symbols by rearranging reels on which symbols are arranged;

a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
a process of selecting, from the symbol random determination tables, a symbol random determination table which is referred to in a symbol random determination process of selecting a symbol to be rearranged from symbols on an N-th reel to be rearranged (N is an integer 3 or larger), with reference to a combination of symbols which are rearranged on reels which are fewer in number than N and rearranged before the N-th reel and with reference to the symbol random determination table selection table; and
a symbol random determination process of, based on the symbol random determination table selected in the preceding process, randomly selecting a symbol from the symbols on the N-th reel to be rearranged.

According to the arrangement above, the symbol random determination table which is referred to when symbols rearranged on the N-th reel are randomly selected is selected based on a combination of symbols rearranged on the reels which are fewer in number than N and rearranged before the N-th reel. This makes it possible to change the probability of rearrangement of a symbol on the N-th reel in association with a combination of symbols on each of the reels having already been confirmed to be rearranged, with the result that the monotonous game play is avoided.

The present invention relates to a gaming machine including: a display device configured to display a game result by rearranging N (N is three or larger) or more reels on which symbols are arranged;

a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
(1A) a first symbol random determination process of, when a game starts, based on a predetermined symbol random determination table, randomly selecting each symbol to be rearranged from symbols on first to (N−1)-th reels to be rearranged;
(1B) a process of selecting one of the symbol random determination tables with reference to a combination of the symbols selected in the first symbol random determination process and the symbol random determination table selection table;
(1C) a second symbol random determination process of randomly selecting a symbol to be rearranged from symbols on the N-th reel to be rearranged, based on the symbol random determination table selected in the process (1B); and
(1D) a process of displaying the symbols selected in the first symbol random determination process and the second symbol random determination process by rearranging the first to N-th reels to be rearranged.

According to the arrangement above, in accordance with a combination of symbols rearranged on the first to (N−1)-th reels, a symbol random determination table which is referred to when a symbol rearranged on the N-th reel is randomly determined is selected. This makes it possible to change the probability of rearrangement of a symbol on the N-th reel in association with a combination of symbols rearranged on the first to (N−1)-th reels, with the result that the monotonous game play is avoided.

In the present invention, the above-described gaming machine is arranged such that,

in the symbol random determination table selection table, a symbol random determination table corresponding to a combination of symbols including the predetermined symbol defines that the probability of rearrangement of the predetermined symbol is higher than the probability in a symbol random determination table corresponding to a combination of symbols not including the predetermined symbol.

According to the arrangement above, when a combination of symbols rearranged on the first to (N−1)-th reels include the predetermined symbol, the probability of rearrangement of the predetermined symbol on the N-th reel is high, with the result that the monotonousness in the game play is avoided.

In the present invention, the above-described gaming machine is arranged such that,

when a combination of the symbols determined in the first symbol random determination process in (1A) is a combination of symbols including the predetermined symbol, in the process (1B), the symbol random determination table selection table in which the probability of rearrangement of the predetermined symbol in the symbol random determination table corresponding to a combination of symbols including the predetermined symbol is higher than the probability of rearrangement of the predetermined symbol in the symbol random determination table corresponding to a combination of symbols not including the predetermined symbol is selected.

According to the arrangement above, when a combination of symbols rearranged on the first to (N−1)-th reels include the predetermined symbol, the probability of rearrangement of the predetermined symbol on the N-th reel is high, with the result that the monotonousness in the game play is avoided.

In the present invention, the above-described gaming machine is arranged such that,

the display displays a game result by a combination of symbols formed by rearranging N (N is 3 or larger) reels, on which symbols are provided, in a matrix-shaped display areas, and
in the symbol random determination table selection table, a symbol random determination table corresponding to a combination of symbols including the predetermined symbol is a symbol random determination table which defines that the probability of rearrangement of the predetermined symbol in a predetermined display area is higher than the probability in a symbol random determination table corresponding to a combination of symbols not including the predetermined symbol.

According to the arrangement above, when a combination of symbols rearranged on the first to (N−1)-th reels includes a predetermined symbol, the probability of rearrangement of the predetermined symbol in a predetermined display area is increased for a symbol rearranged on the N-th reel. With this, the predetermined symbol is more likely to be displayed in the predetermined display area of the display, and hence monotonous game play is avoided.

The present invention relates to a gaming machine including: a display device configured to display symbols by rearranging reels on which symbols are arranged;

a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
selecting, from the symbol random determination tables, a symbol random determination table which is referred to in a symbol random determination process of selecting a symbol to be rearranged from symbols on a predetermined-number-th reel to be rearranged, with reference to a combination of symbols rearranged on the first to ((predetermined number)−1)-th reels and the symbol random determination table selection table; and
based on the symbol random determination table selected in the process above, randomly selecting a symbol to be rearranged, from the symbols on the predetermined-number-th reel to be rearranged.

According to the arrangement above, in accordance with a combination of symbols rearranged on the first to ((predetermined number)−1)-th reels, a symbol random determination table which is referred to when a symbol rearranged on the predetermined-number-th reel is randomly determined is selected. This makes it possible to change the probability of rearrangement of a symbol on the predetermined-number-th reel in association with a combination of symbols rearranged on the previous reels, with the result that the monotonous game play is avoided.

A gaming machine which makes it possible to avoid monotonous game play is provided.

### BRIEF DESCRIPTION OF THE DRAWINGS

FIG. 1 shows the outline of game content of a slot machine according to an embodiment of the present invention.

FIG. 2 shows a functional flow of the slot machine of the embodiment of the present invention.

FIG. 3 shows a game system including the slot machine of the embodiment of the present invention.

FIG. 4 shows the overall structure of the slot machine of the embodiment of the present invention.

FIG. 5 shows a symbol array on each reel of the slot machine of the embodiment of the present invention.

FIG. 6 is an explanatory diagram of a reel displayed in a display window of the slot machine of the embodiment of the present invention.

FIG. 7 is an explanatory diagram of a liquid crystal display device of the slot machine of the embodiment of the present invention.

FIG. 8 is a block diagram showing an internal structure of the slot machine of the embodiment of the present invention.

FIG. 9 shows a symbol combination table of the slot machine of the embodiment of the present invention.

FIG. 10 shows a symbol random determination table for a first reel of the slot machine of the embodiment of the present invention.

FIG. 11 shows a symbol random determination table for a second reel of the slot machine of the embodiment of the present invention.

FIG. 12 shows a symbol random determination table for a third reel of the slot machine of the embodiment of the present invention.

FIG. 13 shows a symbol random determination table selection table for the second reel of the slot machine of the embodiment of the present invention.

FIG. 14 shows a symbol random determination table selection table for the third reel of the slot machine of the embodiment of the present invention.

FIG. 15 is a flowchart of a main control process in the slot machine of the embodiment of the present invention.

FIG. 16 is a flowchart of a bet/start-check process of the slot machine of the embodiment of the present invention.

FIG. 17 illustrates game progress in the slot machine of the embodiment of the present invention.

FIG. 18 shows the outline of game content of a slot machine according to an embodiment of the present invention.

FIG. 19 shows a functional flow of the slot machine of the embodiment of the present invention.

FIG. 20 shows a game system including the slot machine of the embodiment of the present invention.

FIG. 21 shows the overall structure of the slot machine of the embodiment of the present invention.

FIG. 22 shows a symbol array on each reel of the slot machine of the embodiment of the present invention.

FIG. 23 is an explanatory diagram of a reel displayed in a display window of the slot machine of the embodiment of the present invention.

FIG. 24 illustrates the liquid crystal display device of the slot machine of the embodiment of the present invention.

FIG. 25 is a block diagram showing an internal structure of the slot machine of the embodiment of the present invention.

FIG. 26 shows a symbol combination table of the slot machine of the embodiment of the present invention.

FIG. 27 shows a symbol random determination table for a first reel of the slot machine of the embodiment of the present invention.

FIG. 28 shows a symbol random determination table for a second reel of the slot machine of the embodiment of the present invention.

FIG. 29 shows a symbol random determination table for a third reel of the slot machine of the embodiment of the present invention.

FIG. 30 shows a symbol random determination table selection table for the third reel of the slot machine of the embodiment of the present invention.

FIG. 31 is a flowchart of a main control process in the slot machine of the embodiment of the present invention.

FIG. 32 is a flowchart of a bet/start-check process of the slot machine of the embodiment of the present invention.

FIG. 33 illustrates game progress in the slot machine of the embodiment of the present invention.

### DETAILED DESCRIPTION OF THE PREFERRED EMBODIMENT

### Outline of First Embodiment

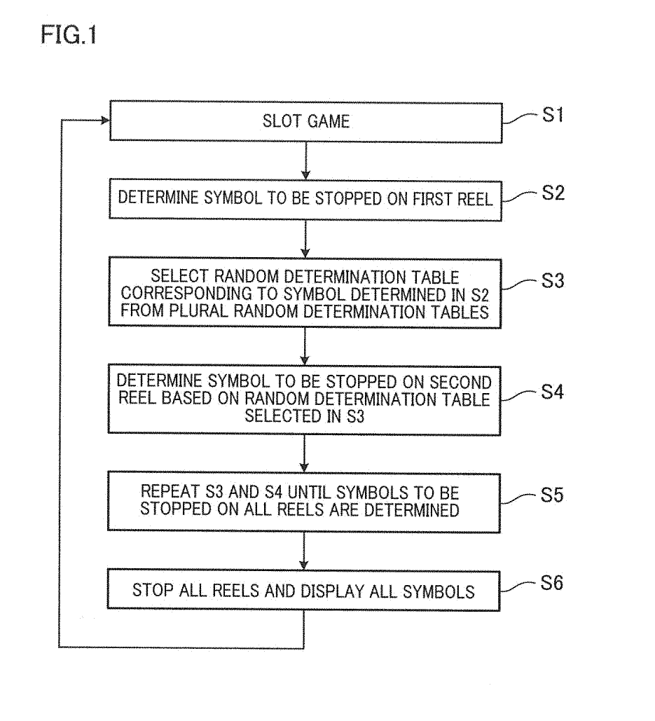

The following will describe an embodiment of the present invention with reference to the drawings. FIG. 1 shows the outline of a game flow of a slot machine according to the embodiment of the present invention. As shown in FIG. 1, the slot machine of the embodiment of the present invention executes a slot game.

The slot games are of a line type (Left to Right). The slot games employ mechanical reels. The reels are formed of three reels. That is to say, the reels are formed of a first reel, a second reel, and a third reel. Furthermore, a single payline is set.

In the slot game, based on a symbol random determination table in which a probability of rearrangement of symbols lined up on three reels in a display window is associated with each symbol, a symbol random determination process is carried out to randomly determine symbols to be rearranged in the display window, the determined symbols are rearranged in the display window, and a benefit is awarded based on a combination of symbols rearranged on a payline (equivalent to an arrangement pattern).

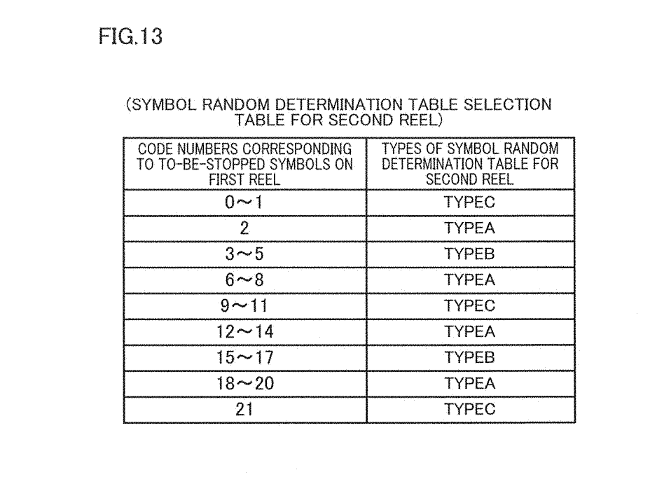

To be more specific, as shown in FIG. 1, when the slot game starts (S1), symbols stopping at the first reel are randomly determined based on a symbol random determination table for the first reel (S2). Subsequently, a random determination table corresponding to the symbols determined in S2 is selected from plural random determination tables (a later-described symbol random determination table selection table for the second reel shown in FIG. 13 is referred to) (S3). Subsequently, symbols stopping at the second reel are determined based on the random determination table selected in S3 (S4). The steps S3 and S4 are repeated until symbols stopping at all reels are determined (S5). Thereafter, all reels stop in the display window and all symbols are displayed on the display window (rearranged) (S6).

### Definitions

The slot game in the present embodiment is run by the slot machine 1. The slot game is a game of rearranging symbols. The rearrangement of symbols in the slot game is carried out by a mechanical reel unit (equivalent to a display device). In the slot game, on condition that a gaming value is bet, symbols are rearranged in the display window by the mechanical reel unit, and a payout is awarded according to the rearranged symbols. In addition to the above, for example, a free game which does not require betting of a gaming value, a game in which a payout amount and a payout rate are higher than those in the normal game, a mini game different from the normal game, or a game in which a predetermined condition is more probable to be established as compared to the normal game may be executed.

The symbols collectively mean “FIRE7”, “RED7”, “3BAR”, “2BAR”, “1BAR”, and “BLANK”.

The gaming value is electrically valuable information such as electronic money and the like. It is to be noted that the gaming value in the disclosure is not limited to these, and for example a gaming medium such as a medal, a token, a coin, a ticket or the like can be adopted. The ticket is not particularly limited, and for example, a ticket having data of credit amount and the like in the form of bar code. Alternatively, the gaming value may be a game point not including valuable information.

The term “rearrangement” indicates that the symbols are rearranged after the arrangement of the symbols is dismissed. Arrangement means a state where the symbols can be visually confirmed by a player. More specifically, “rearrangement” is a state in which, after the symbols on the reels are variably displayed as the reels rotate, the variable display of the symbols stops as the rotation of the reels stops, and the symbols stop in the display window.

(Functional Flow)

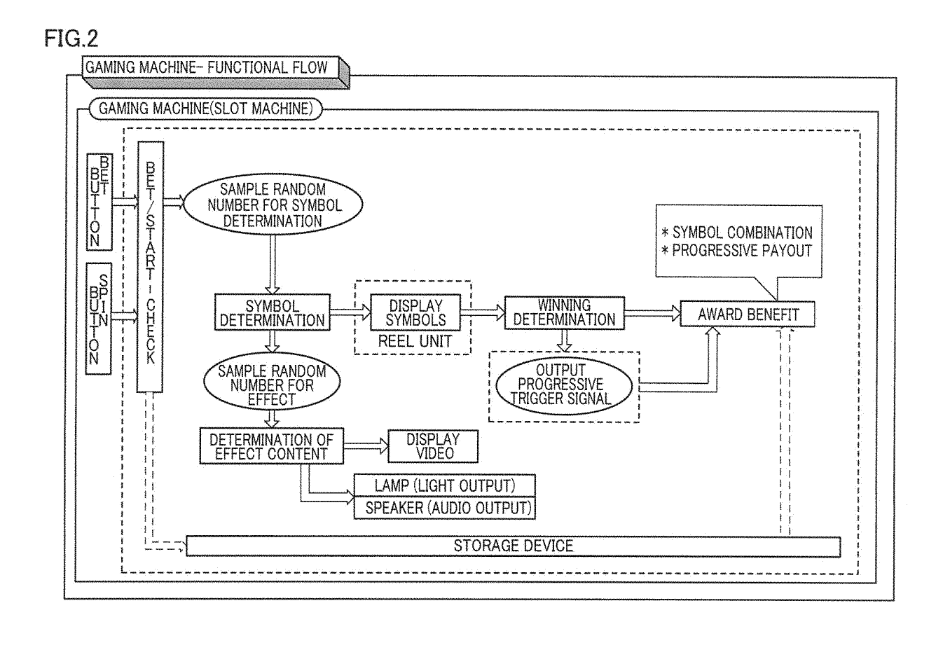

The following describes basic functions of the slot machine related to the embodiment of the present invention, with reference to FIG. 2. FIG. 2 is a diagram showing functional flow of the slot machine related to the embodiment of the present invention.

<Bet/Start-Check>

First, the slot machine checks whether or not a BET button has been pressed by a player, and subsequently checks whether or not a spin button has been pressed by the player.

<Symbol Determination>

Subsequently, when the spin button is pressed by the player, the slot machine extracts a random number for symbol determination, and determines, with reference to the symbol random determination table selected in the symbol random determination table random determination, symbols to be displayed (rearranged) for the player at the time of stopping the scroll of the reel, for respective reels.

<Reel Control>

Thereafter, the slot machine starts the rotation of each reel and stops the rotation of each reel so that the determined symbols are displayed for the player (symbol display).

<Winning Determination>

Subsequently, as the rotation of each reel is stopped, the slot machine determines whether the combination of the symbols displayed for the player is a combination related to winning.

<Awarding Benefit>

When the combination of the symbols displayed for the player is a combination related to winning, the slot machine offers, to the player, benefit according to the type of the combination. For example, when a combination of symbols related to awarding of a credit is displayed, the slot machine awards credits to the player, the amount of which corresponds to the combination of the symbols.

In addition to the above, the slot machine may accumulatively add a part of a bet amount to progressive payout stored in the storage device, each time the unit game is executed. When progressive payout is employed, the slot machine awards the progressive payout accumulatively stored in the storage device to the player, when a progressive trigger condition is established. The progressive (jackpot) is a function of accumulating at least one of coins betted by a player at a slot machine (or slot machines) in the progressive payout and awarding the accumulated progressive payout to a slot machine in which a progressive trigger is established. When the progressive payout is accumulated by plural slot machines, an amount (accumulative amount) accumulated to the progressive payout is calculated and transmitted to an external controller each time the game is executed. The external controller adds the accumulative amount sent from each slot machine to the progressive payout.

The slot machine may have other benefits such as a mystery bonus and insurance. In the mystery bonus, a predetermined number of coins are paid out when a winning is achieved in dedicated random determination. When a spin button is pressed, the slot machine samples a random number for the mystery bonus, and whether a mystery bonus trigger is established is randomly determined.

The insurance is a function for saving the player when the free game is not executed for a long period of time. Whether the insurance is activated or not is freely determined by an administrator of the slot machine. When the insurance is activated, a predetermined insurance activation amount must be paid. When the insurance is activated, the slot machine starts to count the number of plays of the game. When the counted number of plays reaches a predetermined number without a large amount of payout, the slot machine pays out coins, the amount of which has been set for the insurance.

<Determination of Effect>

The slot machine produces an effect by displaying an image on a display, outputting light from a lamp, and outputting sound from a speaker. The slot machine extracts an effect-use random number and determines the contents of the effect based on randomly determined symbols or the like.

[Overall Structure of Game System]

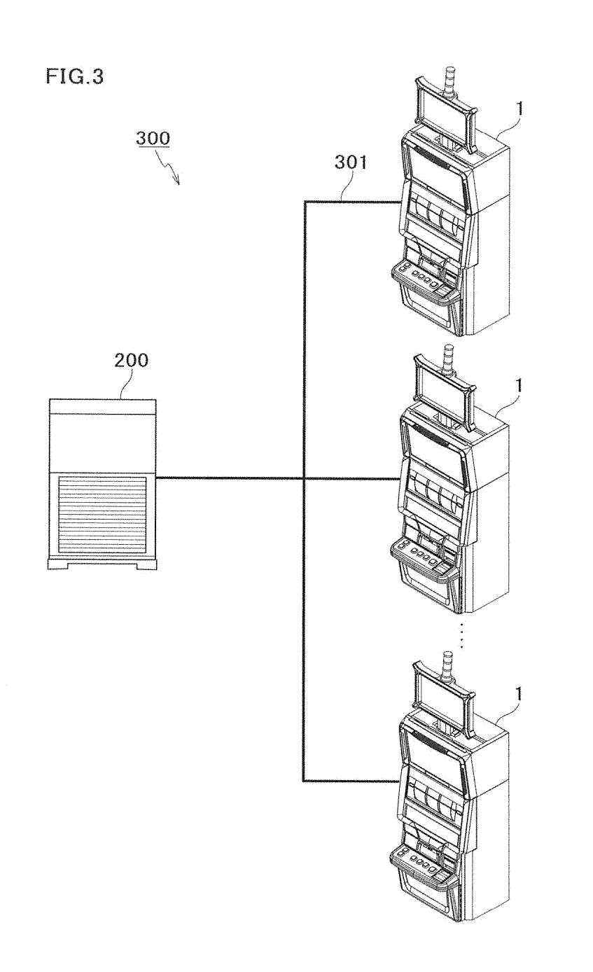

The basic functions of the slot machine have been described as above. Now, referring to FIG. 3, a game system including the slot machine will be described. FIG. 3 shows a game system including the slot machine of the embodiment of the present invention.

The game system 300 includes the slot machines 1 and an external controller 200 connected to each slot machine 1 over communication lines 301.

The external controller 200 is configured to control the slot machines 1. In the embodiment of the present invention, the external controller 200 is a so-called hall server installed in a gaming facility where the plurality of slot machines 1 are provided. Each of the slot machines 1 has a unique identification number, and the external controller 200 identifies which one of the slot machines 1 transmitted data, by referring to the identification number. Further, when transmitting data from the external controller 200 to any of the slot machines 1, the identification number is used for designating the transmission destination.

The game system 300 may be constructed in a single gaming facility such as a casino where various games are playable or may be constructed for a plurality of gaming facilities. Further, when the game system 300 is constructed in a single gaming facility, the gaming system may be constructed in each floor or section of the gaming facility. The communication line 301 may be a wired or wireless line, and can adopt a dedicated line, an exchange line, or the like.

The game system 300 is of a network type in which the slot machines 1 are connected with the external controller 200 by a communication line 301, but the game system 300 may be of a standalone type in which each slot machine 1 independently executes a game.

[Overall Structure of Slot Machine]

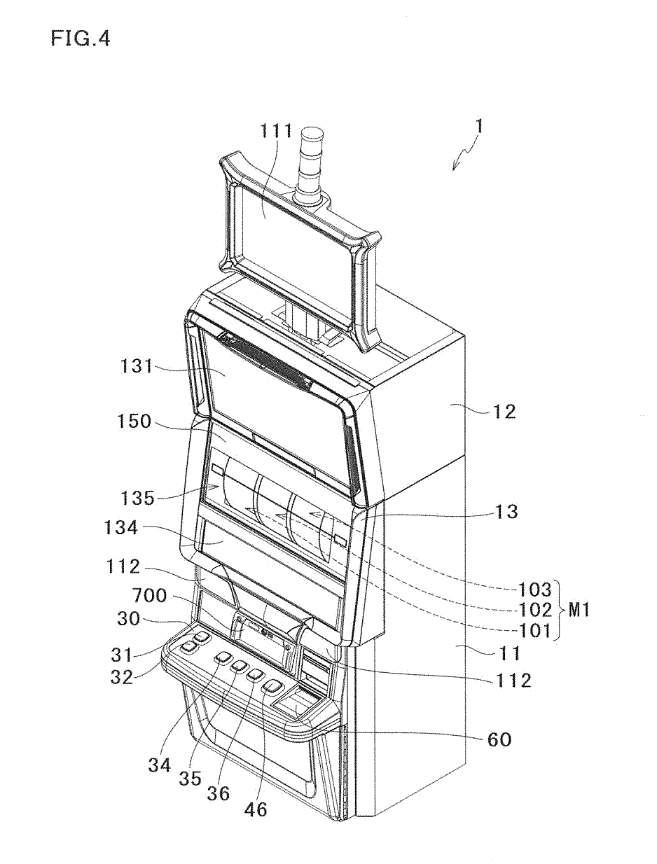

Now, referring to FIG. 4, the overall structure of the slot machine 1 will be described. FIG. 4 shows the overall structure of the slot machine of the embodiment of the present invention.

Electrically valuable information such as electronic money is used as a gaming value in the slot machine 1. It is to be noted that the gaming value is not limited to this, and for example a coin, a medal, a token, a ticket with a bar code and the like can be adopted.

The slot machine 1 includes a cabinet 11, a top box 12 installed on the upper side of the cabinet 11, and a main door 13 provided at the front surface of the cabinet 11. Above the top box 12, a digital signage 111 is provided.

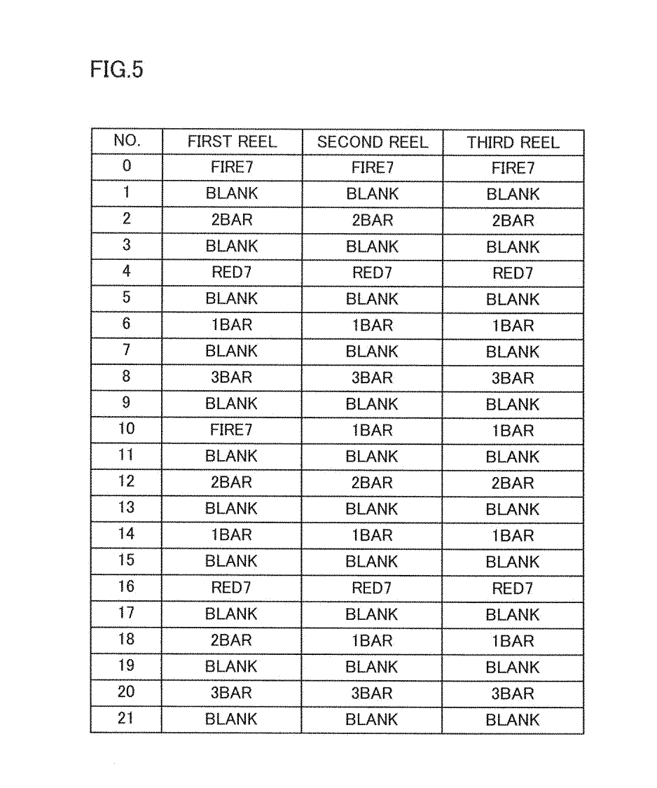

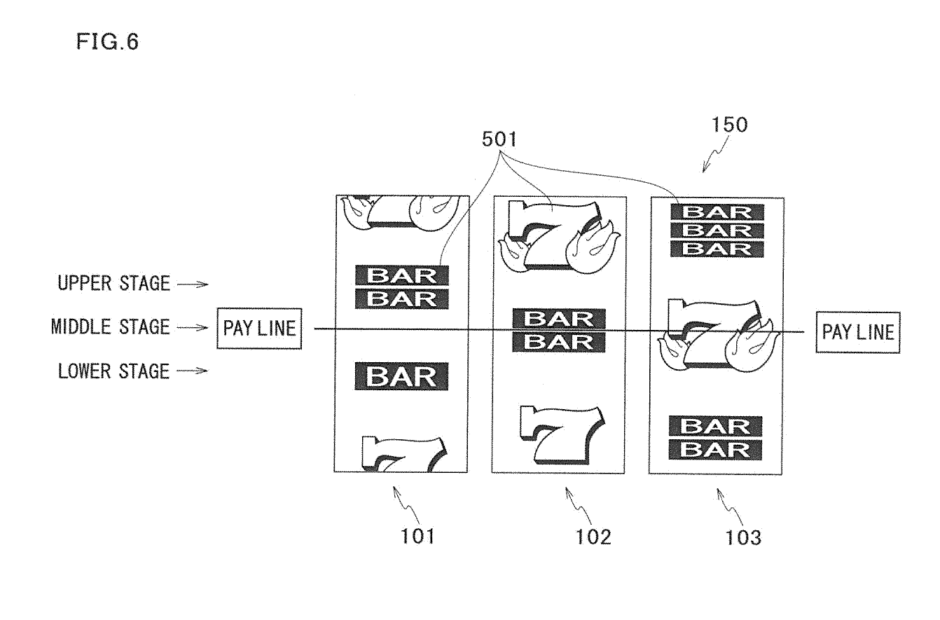

The main door 13 is provided with a reel unit M1 (corresponding to a symbol display device) constituted by three reels 101, 102, and 103. A reel cover 135 is provided in front of the reel unit M1. On the front surface of the reel cover 135, a liquid crystal display device 134 by which a game status is reported to the player and a transparent panel are provided. This liquid crystal display device 134 is provided with a touch panel 137. The reel cover 135 has a display window 150 (equivalent to a display device) at its central portion. In the display window 150, one symbol 501 is provided in each of the upper stage, the middle stage, and the lower stage of each of the reels 101, 102, and 103 (see FIG. 6). To put it differently, 9 symbols 501 forming a 3 by 3 matrix are visibly displayed in the display window 150. On the outer circumferential surface of each of the reels 101, 102, and 103, 22 symbols are depicted (see FIG. 5). These 22 symbols 501 are lined up along the rotational direction of the reels 101, 102, and 103 to form a symbol array. Each of the symbol arrays is a combination of “FIRE7”, “RED7”, “3BAR”, “2BAR”, “1BAR”, and “BLANK”. To the main door 13 is provided a speaker 112.

As shown in FIG. 6, a payline for result determination of symbols 501 rearranged in the display window 150 is set in the slot machine 1. In the present embodiment, one payline is formed at the middle stage of the display window 150 as shown in FIG. 6. Alternatively, plural paylines may be provided and each payline may be activated upon selection by a player.

As shown in FIG. 6, the reel unit M1 rearranges the symbols 501 on the display window 150 by drivingly rotating the reels 101, 102, and 103 each having the symbols 501 on the outer circumferential surface. In the descriptions below, the reels may be referred to as a first reel 101, a second reel 102, and a third reel 103 from the left end in front elevation.

On the inner circumferential side of each of the reels 101, 102, and 103 arranged as above, a backlight unit (not illustrated) is provided. The backlight unit emits illumination light from the inner circumferential side of the reels 101, 102, and 103 to the outer circumferential surface of the reels and is arranged so that the illumination light passing through the outer circumferential surface of the reels is seen from the outside of the display window 150. The backlight unit is configured to be able to change the amount of illumination light in multiple stages. The degree of freedom in the effects using illumination light is therefore high. Furthermore, each backlight unit is able to emit light in multiple colors, and to illuminate the symbols individually with the illumination light.

It should be noted that the present embodiment deals with a case where the slot machine 1 employs the reel unit M1 in the form of mechanical reels; however, the slot machine 1 of the present invention may adopt video reels that display simulated reels, or adopt a combination of the video reels and the mechanical reels.

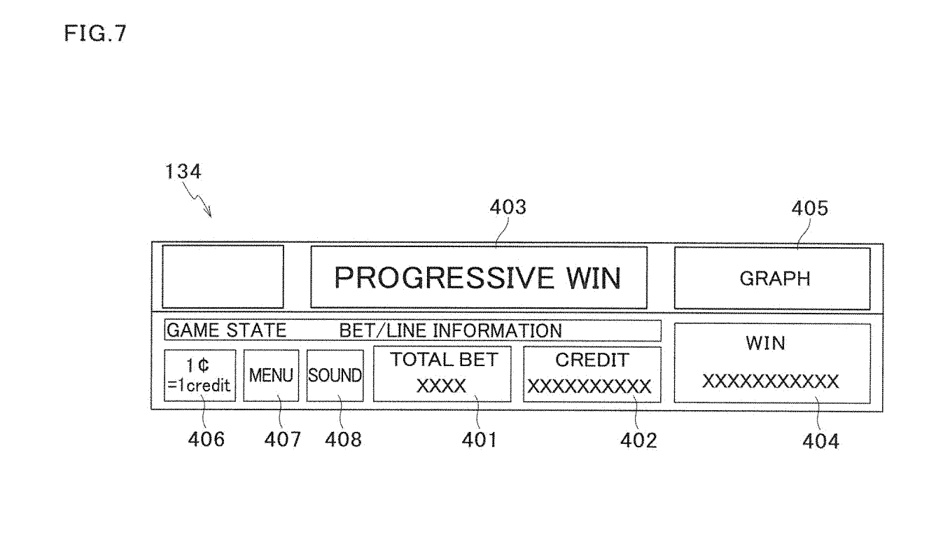

As shown in FIG. 7, on the liquid crystal display device 134 is displayed meters indicating the conditions of the game. For example, a total bet meter 401 displays “Total Bets”. The numerical value is re-calculated at every game play. The credit meter 402 indicates the total credit amount at the time. The default value is 0. The numerical value is increased or decreased according to the gaming value input, the bet, and the game result. A game message area 403 indicates a message explaining the current gaming status. The win meter 404 indicates the total credit amount of the payout having been won.

The liquid crystal display device 134 is provided with a graph touch area 405, a denomination indicator 406, a menu touch area 407, and a sound volume switching touch area 408. When touched by the player, the touch area 405 displays, in the form of graphs, the change of the obtained payout amount, the total number of game play, and the total obtained credit amount on the upper image display panel 131. As the graph touch area 405 is touched, three types of graph images, i.e., line-graph, bar-graph, and block-graph are displayed in order. The denomination indicator 406 displays current denomination. When the menu touch area 407 is touched by the player, the upper image display panel 131 displays the first page of the HELP screen. The sound volume switching touch area 408 is used for switching the game sound volume in three stages. Each time the sound volume switching touch area 408 is touched by the player, the game sound volume is switched such that, for example, from low to middle to high to small to middle.

An upper image display panel 131 is provided at the front surface of the top box 12. The upper image display panel 131 includes a liquid crystal panel, and forms the display. The upper image display panel 131 displays images related to effects and images showing introduction of the game contents and explanation of the game rules.

Below the reel unit M1 are provided a control panel 30 having various buttons, a PTS device 700, and a bill entry 60.

The bill entry 60 validates bills and receives genuine bills into the cabinet 11. The bill entry 60 is electrically connected to the PTS device 700, and when a legitimate bill is received, transmits to the PTS device 700 an input signal based on the value of the bill. The input signal includes information on credit data or the like related to the received bill.

The PTS device 700 is a unit in which an LCD (liquid crystal display), a human body detection camera, a microphone, and the like are integrated. The human detection camera makes it possible to detect the presence of a player by the camera function. The microphone is used for the player's participation in a game by voice and the authentication of a player by voice recognition. Further, the PTS device 700 has a card insertion slot to which an IC card can be inserted. With this, the player is able to insert an IC card into the card insertion slot and use the credits stored in the IC card in the slot machine 1.

(Control Panel 30)

On the control panel 30, a HELP button 31 and a CASHOUT button 32 are arranged in the left side area, a 1-BET button 34, a 2-BET button 35, and a 3-BET button 36 are arranged in the middle area, and a spin button 46 is arranged in the lower stage on the left side area.

The HELP button 31 is pressed when, for example, it is unclear how to play a game. As the HELP button 31 is pressed, various help information is displayed on the upper image display panel 131. The CASHOUT button 32 is an operation button used when checking out credits reserved in the slot machine 1 is discharged.

Each time the 1-BET button 34 is pressed, one of the credits currently owned by the player is betted. The 2-BET button 35 is used to start a game with two bets. The 3-bet button 36 is used to start a game with three bets. A gaming value corresponding to one bet can be optionally changed by setting the denomination.

The spin button 46 is used to start the rotation of the reels 101, 102, and 103.

(Symbol Array)

Now, with reference to FIG. 5, the arrays of the symbols 501 on the first reel 101, the second reel 102, and the third reel 103 of the slot machine 1 will be described.

A symbol table shown in FIG. 5 shows arrays of the symbols 501 displayed on the outer circumferential surfaces of the first reel 101, the second reel 102, and the third reel 103. To each of the first reel 101, the second reel 102, and the third reel 103 is assigned a symbol array including 22 symbols 501 respectively corresponding to code numbers 0 to 21.

As shown in FIG. 5, the types of the symbols include “FIRE7”, “RED7”, “3BAR”, “2BAR”, “1BAR”, and “BLANK”.

[Structures of Circuits Provided to Slot Machine]

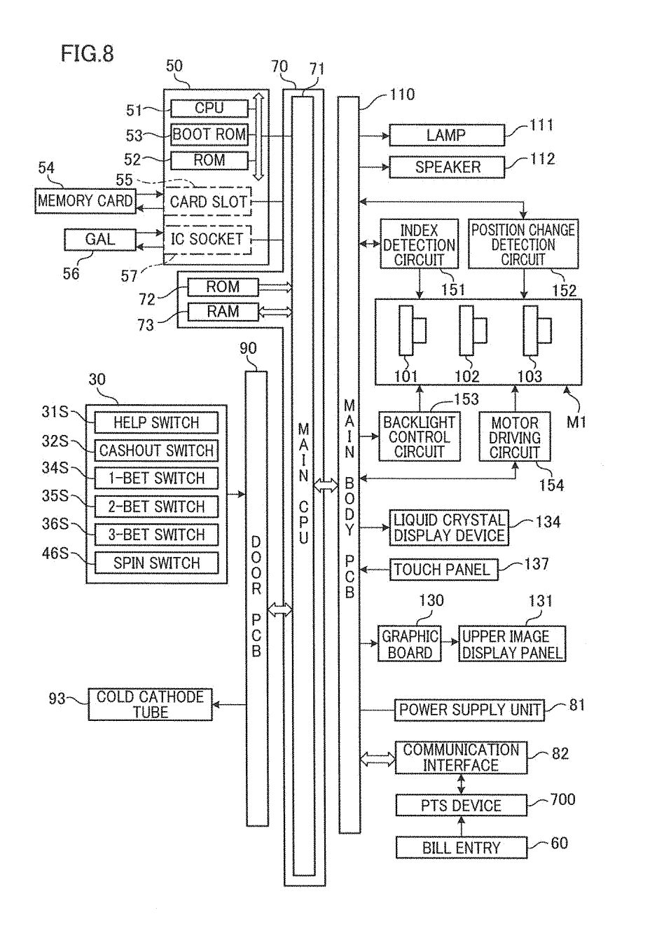

Now, referring to FIG. 8, the configuration of a circuit in the slot machine 1 will be described. FIG. 8 is a block diagram showing an internal structure of the slot machine of the embodiment of the present invention.

A gaming board 50 is provided with a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and an effect program for producing effects by images and sounds.

Further, the card slot 55 is configured so that the memory card 54 can be inserted thereinto and removed therefrom, and is connected to a motherboard 70 by an IDE bus. The type and contents of the game to be played on the slot machine 1 can be changed by drawing out the memory card 54 from the card slot 55, writing another game program into the memory card 54, and inserting the memory card 54 into the card slot 55.

The GAL 56 is a type of PLD (programmable logic device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like. The authentication program is a program (falsification check program) for authenticating the game program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 correspond to a storage device.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started.

The processor of the present invention includes the main CPU 71, the ROM 72, and the RAM 73 above and the memory card 54 storing the game program, and controls the slot machine by causing the main CPU 71 to execute the game program. Needless to say, the processor may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations when these programs are executed. Examples of the areas include: an area that stores counter which manages the number of game play, a bet amount, the credit amount, a payout value of each progressive payout, and the like; and an area that stores symbols (code numbers) randomly determined.

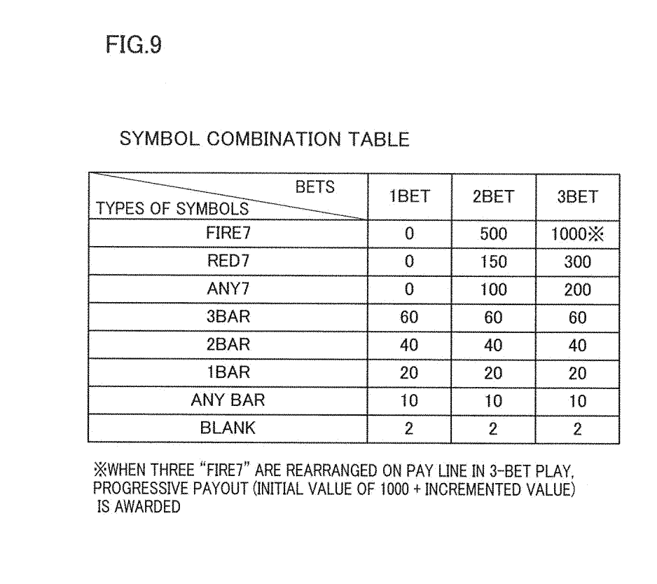

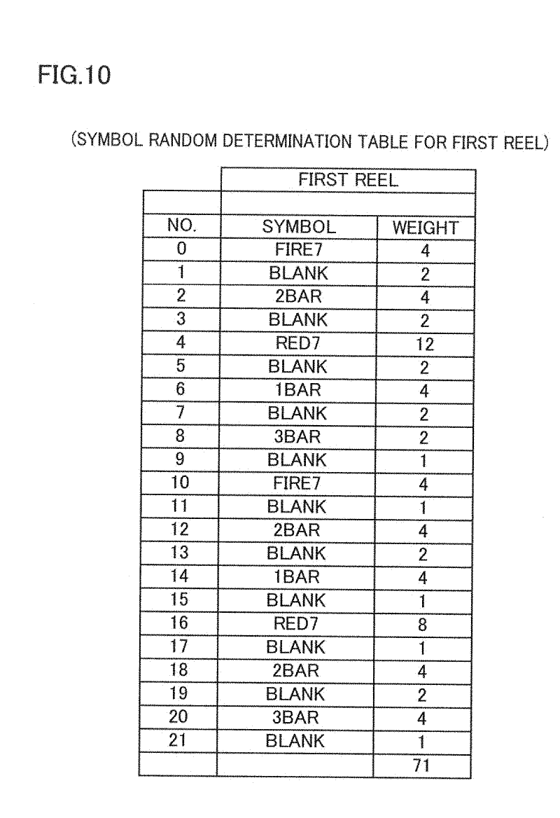

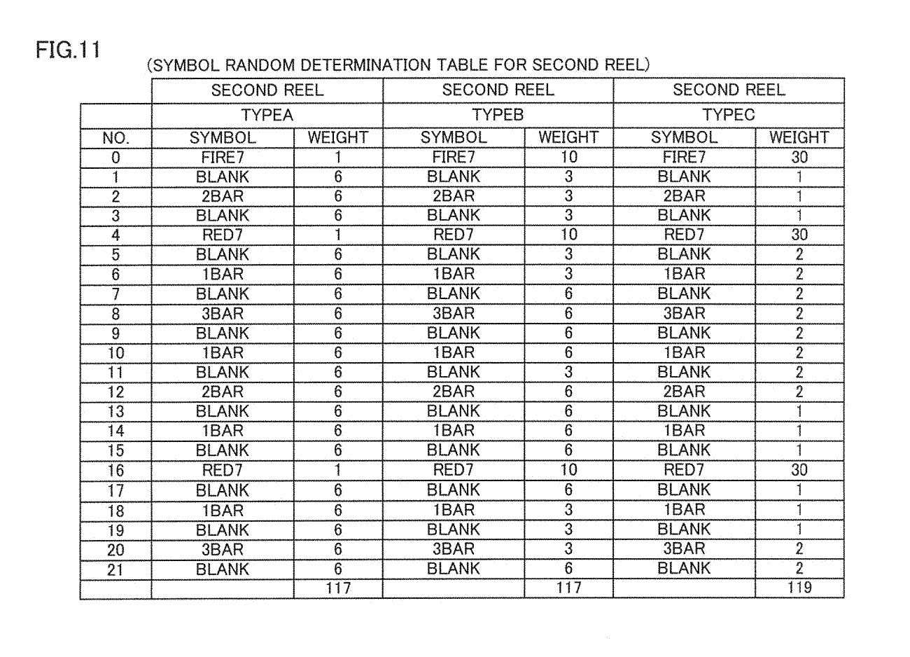

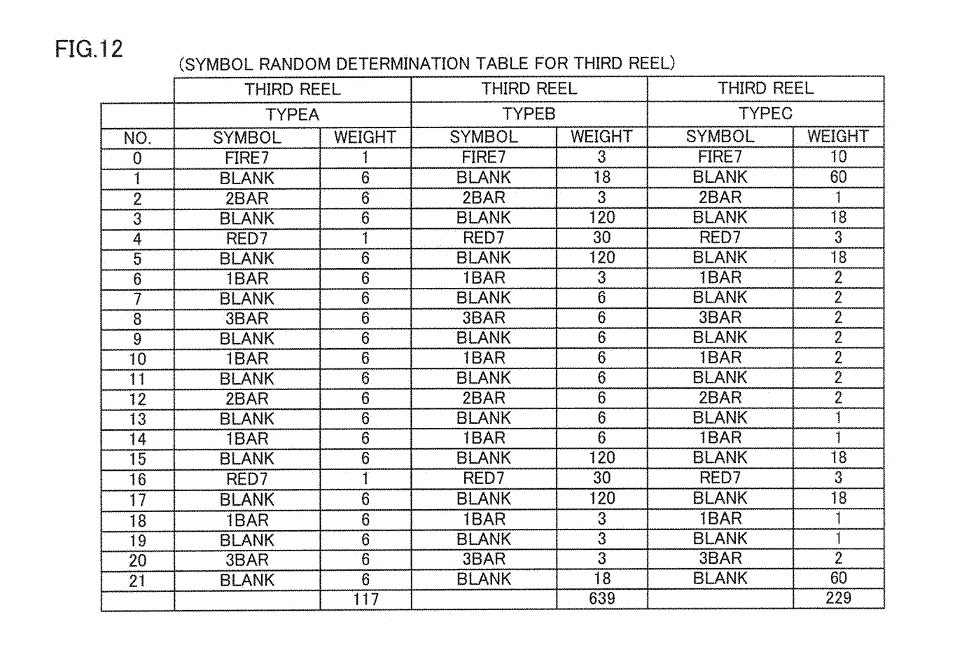

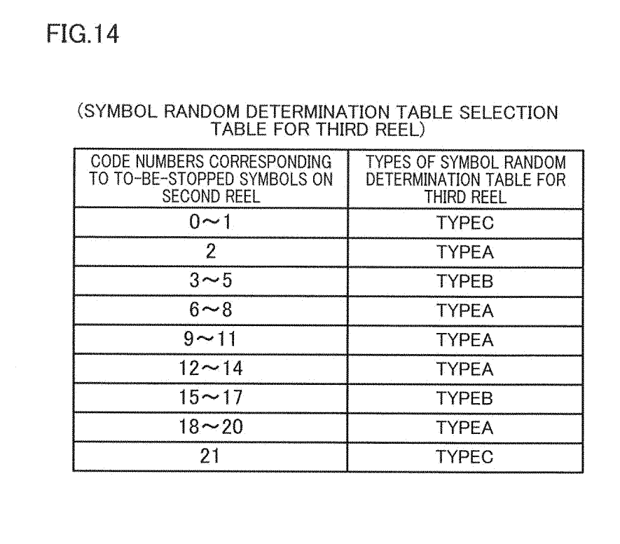

In addition to the above, the RAM 73 stores tables such as a symbol combination table (see FIG. 9), a symbol random determination table for the first reel (see FIG. 10), a symbol random determination table for the second reel (see FIG. 11), a symbol random determination table for the third reel (see FIG. 12), a symbol random determination table selection table for the second reel (see FIG. 13), and a symbol random determination table selection table for the third reel (see FIG. 14).

The communication interface 82 is for communicating with the PTS device 700 and the external controller 200. The PTS device 700, upon reception of an input signal from the bill entry 60, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with the control panel 30, and a cold cathode tube 93.

The control panel 30 is provided with a HELP switch 31S, a CASHOUT switch 32S, a 1-BET switch 34S, a 2-BET switch 35S, a 3-BET switch 36S, and a spin switch 46S, correspondingly to the above-described buttons. Each of the switches outputs a signal to the main CPU 71 upon detection of press of the button corresponding thereto by the player.

The cold cathode tube 93 functions as a backlight installed on the rear face side of the upper image display panel 131, and lights up based on a control signal output from the main CPU 71.

The body PCB 110 is connected with a lamp 111, a speaker 112, a graphic board 130, the liquid crystal display device 134, a touch panel 137, an index detection circuit 151, a position change detection circuit 152, a backlight control circuit 153, and a motor driving circuit 154. The index detection circuit 151, the position change detection circuit 152, a backlight control circuit 153, and a motor driving circuit 154 are connected with the reel unit M1.

The lamp 111 turns on based on a control signal outputted from the main CPU 71. The speaker 112 outputs BGM sound or the like in accordance with a control signal output from the main CPU 71.

The graphic board 130 controls displaying of images on the upper image display panel 131 based on a control signal output from the main CPU 71. The graphic board 130 is provided with a VDP (video display processor) configured to generate image data, a video RAM configured to store the image data generated by the VDP, and the like. It is to be noted that the image data used for generating image data by the VDP is included in the game program that has been read from the memory card 54 and stored into the RAM 73.

The liquid crystal display device 134 displays an image based on a control signal output from the main CPU 71. The touch panel 137 detects a position on the liquid crystal display device 134 touched by a finger or the like of the player, and outputs a signal corresponding to the detected position to the main CPU 71.

The motor driving circuit 154 is connected to a stepper motor configured to rotate the reels 101, 102, and 103. Further, the motor driving circuit 154 includes an FPGA (Field Programmable Gate Array) and a driver. The FPGA is an electronic circuit such as a programmable LSI, and functions as a control circuit of the stepping motor. The driver functions as an amplifying circuit for pulses to be input to the stepping motor.

The index detection circuit 151 detects the positions of the rotating reels 101, 102, and 103 and is able to detect the step out of the reels 101, 102, and 103.

The position change detection circuit 152 is configured to detect a change in the stop position of the reels 101, 102, and 103 after the rotation of the reels 101, 102, and 103 is stopped. The position change detection circuit 152 detects a change in the stop positions of the reels 101, 102, and 103 when, for example, a stop position is changed to achieve a winning combination of the symbols 501 by an illicit way when no winning combination of the symbols 501 is achieved. The position change detection circuit 152 is configured to detect a change in the stop position of the reels 101, 102, and 103, for example, by detecting not-shown fins which is arranged on the inner sides of the reels 101, 102, and 103 at predetermined intervals.

It should be noted that the method of exciting the stepper motor is not particularly limited, and 1-2 phase excitation system or a 2 phase excitation system are adoptable. Further, a DC motor may be adopted in place of the stepper motor. In cases of adopting a DC motor, the main body PCB 110 is connected to an error counter, a D/A converter, a servo amplifier in this order, and the DC motor is connected to the servo amplifier. Further, the rotational position of the DC motor is detected by the rotary encoder, and the rotary encoder supplies the current rotational position of the DC motor in the form of data to the error counter.

The backlight control circuit 153 is connected to the backlight units to individually supply driving power thereto. Upon receiving an instruction from the main CPU 71, the backlight control circuit 153 changes the amount of light emitted in multiple stages. The five backlight units provided on the inner circumferential surfaces of the reels 101, 102, and 103 are able to individually illuminate 9 symbols 501 having stopped on the display window 150 by means of the backlight control circuit 153.

(Symbol Combination Table)

Now, symbol combination tables will be described with reference to FIG. 9. FIG. 9 shows a symbol combination table in the slot machine of the embodiment of the present invention.

The symbol combination table defines payouts for bet amounts and symbol combinations achieving winning (WIN). In the slot machine 1, the rotational scroll of the reels 101, 102, and 103 is stopped, and when a combination of three symbols displayed (rearranged) on a payline corresponds to a symbol combination defined in the symbol combination table, winning is achieved. In accordance with the type of winning, a benefit will be given to the player in the form of awarding payout and the like. It is noted that winning is not established (i.e. the game is lost) when the combination of symbols displayed (rearranged) on the payline does not match with any of the combinations of symbols specified by the symbol combination table.

Basically, winning is achieved when three symbols of the following types are displayed on a payline: “FIRE7”, “RED7”, “3BAR”, “2BAR”, “1BAR”, and “BLANK”. Furthermore, winning is achieved as “ANY7” when a symbol combination including “FIRE7” and “RED7” is established. Winning as “ANYBAR” is also achieved when a symbol combination including “3BAR”, “2BAR”, and “1BAR” is established. When the game is played with one bet, no payout is awarded for “FIRE7”, “RED7”, and “ANY7”. When the game is played with three bets, progressive payout (initial value 1000+incremented amount) is awarded when three “FIRE7” are rearranged on a payline.

(Symbol Random Determination Table for First Reel)

Now, the symbol random determination table for the first reel will be described with reference to FIG. 10. In the present embodiment, the random determination table for the first reel is a random determination table defining probabilities of 22 symbols regarding the first reel 101, which is referred to in a first reel symbol random determination process of determining symbols of the first reel 101 to be rearranged in the middle stage (payline) of the display window 150 in a main control process which will be described later.

In the symbol random determination table for the first reel, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in the symbol random determination table for the first reel shown in FIG. 10, “FIRE7” of the first reel 101 corresponding to the code number “0” is rearranged in the middle stage of the display window 150 (on the payline) at a probability of 4/71. “BLANK” of the first reel 101 corresponding to the code number “1” is rearranged in the middle stage of the display window 150 (on the payline) at a probability of 2/71. “RED7” of the first reel 101 corresponding to the code number “4” is rearranged in the middle stage of the display window 150 (on the payline) at a probability of 12/71.

(Symbol Random Determination Table for Second Reel)

Now, the symbol random determination table for the second reel will be described with reference to FIG. 11. In the present embodiment, the random determination table for the second reel is a random determination table defining probabilities of 22 symbols regarding the second reel 102, which is referred to in a second reel symbol random determination process of determining symbols of the second reel 102 to be rearranged in the middle stage (payline) of the display window 150 in the main control process which will be described later. There are three types of the symbol random determination tables for the second reel, namely Type A, Type B, and Type C. Which type of the symbol random determination table for the second reel, Type A, Type B, or Type C, is used is determined in the later-described second reel symbol random determination table selection process.

As shown in FIG. 11, in the Type-A symbol random determination table for the second reel, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in the Type-A symbol random determination table for the second reel shown in FIG. 11, “FIRE7” of the second reel 102 corresponding to the code number “0” is rearranged in the middle stage of the display window 150 (on the payline) at a probability of 1/117. “BLANK” of the second reel 102 corresponding to the code number “1” is rearranged in the middle stage of the display window 150 (on the payline) at a probability of 6/117. “RED7” of the second reel 102 corresponding to the code number “4” is rearranged in the middle stage of the display window 150 (on the payline) at a probability of 1/117.

As shown in FIG. 11, in the Type-B symbol random determination table for the second reel, probabilities (WEIGHT) are set for 22 symbols corresponding to code numbers “0” to “21”, respectively. For example, in the Type-B symbol random determination table for the second reel shown in FIG. 11, “FIRE7” of the second reel 102 corresponding to the code number “0” is rearranged in the middle stage of the display window 150 (on the payline) at a probability of 10/117. “BLANK” of the second reel 102 corresponding to the code number “1” is rearranged in the middle stage of the display window 150 (on the payline) at a probability of 3/117. “RED7” of the second reel 102 corresponding to the code number “4” is rearranged in the middle stage of the display window 150 (on the payline) at a probability of 10/117.

As shown in FIG. 11, in the Type-C symbol random determination table for the second reel, probabilities (WEIGHT) are set for 22 symbols corresponding to code numbers “0” to “21”, respectively. For example, in the Type-C symbol random determination table for the second reel shown in FIG. 11, “FIRE7” of the second reel 102 corresponding to the code number “0” is rearranged in the middle stage of the display window 150 (on the payline) at a probability of 30/119. “BLANK” of the second reel 102 corresponding to the code number “1” is rearranged in the middle stage of the display window 150 (on the payline) at a probability of 1/119. “RED7” of the second reel 102 corresponding to the code number “4” is rearranged in the middle stage of the display window 150 (on the payline) at a probability of 30/119.

(Symbol Random Determination Table for Third Reel)

Now, the symbol random determination table for the third reel will be described with reference to FIG. 12. In the present embodiment, the random determination table for the third reel is a random determination table defining probabilities of 22 symbols regarding the third reel 103, which is referred to in a third reel symbol random determination process of determining symbols of the third reel 103 to be rearranged in the middle stage (payline) of the display window 150 in the main control process which will be described later. There are three types of the symbol random determination tables for the third reel, namely Type A, Type B, and Type C. Which type of the symbol random determination table for the third reel, Type A, Type B, or Type C, is used is determined in the later-described third reel symbol random determination table selection process.

As shown in FIG. 12, in the Type-A symbol random determination table for the third reel, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in the Type-A symbol random determination table for the third reel shown in FIG. 12, “FIRE7” of the third reel 103 corresponding to the code number “0” is rearranged in the middle stage of the display window 150 (on the payline) at a probability of 1/117. “BLANK” of the third reel 103 corresponding to the code number “1” is rearranged in the middle stage of the display window 150 (on the payline) at a probability of 6/117. “RED7” of the third reel 103 corresponding to the code number “4” is rearranged in the middle stage of the display window 150 (on the payline) at a probability of 1/117.

As shown in FIG. 12, in the Type-B symbol random determination table for the third reel, probabilities (WEIGHT) are set for 22 symbols corresponding to code numbers “0” to “21”, respectively. For example, in the Type-B symbol random determination table for the third reel shown in FIG. 12, “FIRE7” of the third reel 103 corresponding to the code number “0” is rearranged in the middle stage of the display window 150 (on the payline) at a probability of 3/639. “BLANK” of the third reel 103 corresponding to the code number “1” is rearranged in the middle stage of the display window 150 (on the payline) at a probability of 18/639. “RED7” of the third reel 103 corresponding to the code number “4” is rearranged in the middle stage of the display window 150 (on the payline) at a probability of 30/639.

As shown in FIG. 12, in the Type-C symbol random determination table for the third reel, probabilities (WEIGHT) are set for 22 symbols corresponding to code numbers “0” to “21”, respectively. For example, in the Type-C symbol random determination table for the third reel shown in FIG. 12, “FIRE7” of the third reel 103 corresponding to the code number “0” is rearranged in the middle stage of the display window 150 (on the payline) at a probability of 10/229. “BLANK” of the third reel 103 corresponding to the code number “1” is rearranged in the middle stage of the display window 150 (on the payline) at a probability of 60/229. “RED7” of the third reel 103 corresponding to the code number “4” is rearranged in the middle stage of the display window 150 (on the payline) at a probability of 3/229.

(Symbol Random Determination Table Selection Table for Second Reel)

Now, the symbol random determination table selection table for the second reel will be described with reference to FIG. 13. The symbol random determination table selection table for the second reel is referred to in the second reel symbol random determination table selection process in the later-described main control process.

In this symbol random determination table selection table for the second reel, code numbers (see FIG. 10) corresponding to to-be-stopped symbols on the first reel 101 determined in the later-described first reel symbol random determination process are associated with the three types, i.e., Type A, Type B, and Type C, of the symbol random determination tables for the second reel referred to in the later-described second reel symbol random determination process.

To be more specific, the Type-C symbol random determination table for the second reel is associated with the code numbers “0” and “1” (“FIRE7” and “BLANK”). The Type-A symbol random determination table for the second reel is associated with the code number “2” (“2BAR”). The Type-B symbol random determination table for the second reel is associated with the code numbers “3” to “5” (“BLANK”, “RED7”, and “BLANK”). The Type-A symbol random determination table for the second reel is associated with the code numbers “6” to “8” (“1BAR”, “BLANK”, and “3BAR”). The Type-C symbol random determination table for the second reel is associated with the code numbers “9” to “11” (“BLANK”, “FIRE7”, and “BLANK”). The Type-A symbol random determination table for the second reel is associated with the code numbers “12” to “14” (“2BAR”, “BLANK”, and “1BAR”). The Type-B symbol random determination table for the second reel is associated with the code numbers “15” to “17” (“BLANK”, “RED7”, and “BLANK”). The Type-A symbol random determination table for the second reel is associated with the code numbers “18” to “20” (“2BAR”, “BLANK”, and “3BAR”). The Type-C symbol random determination table for the second reel is associated with the code number “21” (“BLANK”).

As described above, in the symbol random determination table selection table for the second reel, the Type-C symbol random determination table for the second reel corresponding to the code numbers “0” and “1” (“FIRE7” and “BLANK”), the code numbers “9” to “11” (“BLANK”, “FIRE7”, and “BLANK”), and the code number “21” (“BLANK”) is arranged so that the probability of rearrangement of “FIRE7” (predetermined symbol) is higher than the probabilities in the Type-A and Type-B symbol random determination tables for the second reel corresponding to the other symbols. That is to say, when a symbol rearranged on the first reel 101 is a symbol which corresponds to one of the code numbers “0” and “1” (“FIRE7” and “BLANK”), the code numbers “9” to “11” (“BLANK”, “FIRE7”, and “BLANK”), and the code number “21” (“BLANK”), the probability of rearrangement of “FIRE7” (predetermined symbol) on the second reel 102 where a symbol is rearranged after on the first reel 101 is high. With this, when a symbol rearranged on the first reel 101 is a symbol which corresponds to one of the code numbers “0” and “1” (“FIRE7” and “BLANK”), the code numbers “9” to “11” (“BLANK”, “FIRE7”, and “BLANK”), and the code number “21” (“BLANK”), the probability of rearrangement of “FIRE7” (predetermined symbol) on the second reel 102 where a symbol is rearranged after on the first reel 101 is high, and hence the overall probability of rearrangement of “FIRE7” in the display window 150 is increased and monotonous game play is avoided.

(Symbol Random Determination Table Selection Table for Third Reel)

Now, the symbol random determination table selection table for the third reel will be described with reference to FIG. 14. The symbol random determination table selection table for the third reel is referred to in the third reel symbol random determination table selection process in the later-described main control process.

In this symbol random determination table selection table for the third reel, code numbers (see FIG. 11) corresponding to to-be-stopped symbols on the second reel 102 determined in the later-described third reel symbol random determination process are associated with the three types, i.e., Type A, Type B, and Type C, of the symbol random determination tables for the third reel referred to in the later-described second reel symbol random determination process.

To be more specific, the Type-C symbol random determination table for the third reel is associated with the code numbers “0” and “1” (“FIRE7” and “BLANK”). The Type-A symbol random determination table for the third reel is associated with the code number “2” (“2BAR”). The Type-B symbol random determination table for the third reel is associated with the code numbers “3” to “5” (“BLANK”, “RED7”, and “BLANK”). The Type-A symbol random determination table for the third reel is associated with the code numbers “6” to “8” (“1BAR”, “BLANK”, and “3BAR”). The Type-A symbol random determination table for the third reel is associated with the code numbers “9” to “11” (“BLANK”, “1BAR”, and “BLANK”). The Type-A symbol random determination table for the third reel is associated with the code numbers “12” to “14” (“2BAR”, “BLANK”, and “1BAR”). The Type-B symbol random determination table for the third reel is associated with the code numbers “15” to “17” (“BLANK”, “RED7”, and “BLANK”). The Type-A symbol random determination table for the third reel is associated with the code numbers “18” to “20” (“1BAR”, “BLANK”, and “3BAR”). The Type-C symbol random determination table for the third reel is associated with the code number “21” (“BLANK”).

As described above, in the symbol random determination table selection table for the third reel, the Type-C symbol random determination table for the second reel corresponding to the code numbers “0” and “1” (“FIRE7” and “BLANK”) and the code number “21” (“BLANK”) is arranged so that the probability of rearrangement of “FIRE7” (predetermined symbol) is higher than the probabilities in the Type-A and Type-B symbol random determination tables for the third reel corresponding to the other symbols. That is to say, when a symbol rearranged on the second reel 102 is a symbol which corresponds to one of the code numbers “0” and “1” (“FIRE7” and “BLANK”) and the code number “21” (“BLANK”), the probability of rearrangement of “FIRE7” (predetermined symbol) on the third reel 103 where a symbol is rearranged after on the second reel 102 is high. With this, when a symbol rearranged on the second reel 102 is a symbol which corresponds to one of the code numbers “0” and “1” (“FIRE7” and “BLANK”) and the code number “21” (“BLANK”), the probability of rearrangement of “FIRE7” (predetermined symbol) on the third reel 103 where a symbol is rearranged after on the second reel 102 is high, and hence the overall probability of rearrangement of “FIRE7” in the display window 150 is increased and monotonous game play is avoided.

[Contents of Program]

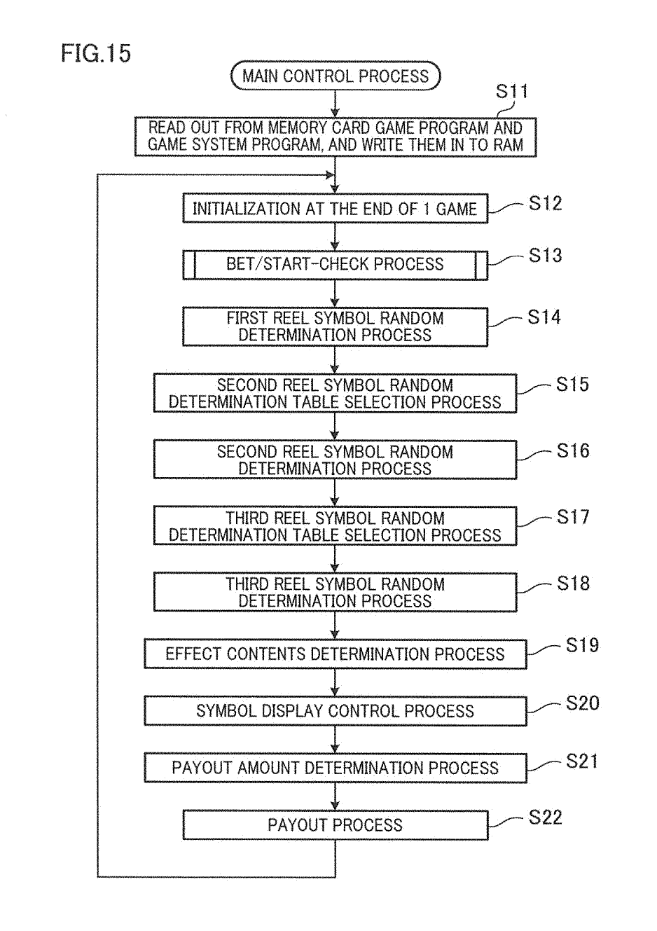

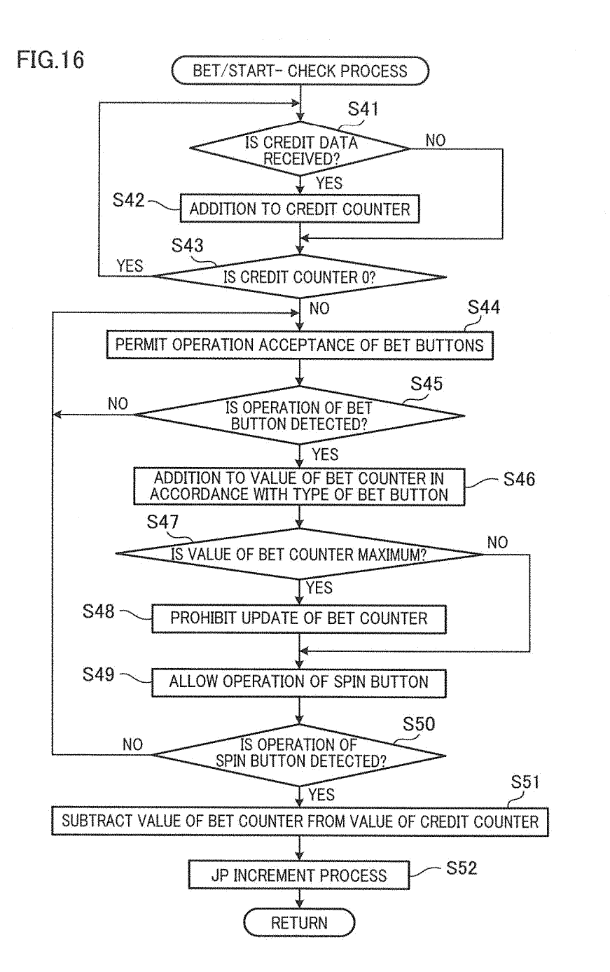

Now, the program to be executed by the slot machine 1 is described with reference to FIG. 15 and FIG. 16.

(Main Control Process)

Referring to FIG. 15, a main control process will be described. In the main control process, a slot game is executed.

First, when the slot machine 1 is powered on, the main CPU 71 reads an authenticated game program and a game system program from a memory card 54 via a gaming board 50, and then write them in the RAM 73 (S11).

Subsequently, the main CPU 71 executes an initializing process at the end of each play of the game, in order to start the slot game (S12). This process clears data in a working area of the RAM 73, which becomes unnecessary at the end of each play of the slot game, e.g., the bet amount, symbols randomly determined, and the like.

The main CPU 71 then executes a later-described bet/start-check process (S13). In this process, an input check or the like is executed for switches such as the 1-BET switch 34S, the 2-BET switch 35S, the 3-BET switch 36S, and the spin switch 46S.

Then, the main CPU 71 executes a first reel symbol random determination process (S14). In this first reel symbol random determination process, based on the probability (WEIGHT) defined in the symbol random determination table for the first reel (see FIG. 10), one to-be-stopped symbol to be rearranged in the middle stage (on the payline) of the display window 150 in regard to the first reel 101 is randomly determined.

For example, when the code number “0” is selected at the random determination probability of 4/71 for the first reel 101, “RED7” corresponding to the code number “0” of the first reel 101 is selected as a to-be-stopped symbol to be rearranged in the middle stage of the display window 150 (on the payline).

The main CPU 71 stores the determined to-be-stopped symbol of the first reel 101 in a symbol storing area in the RAM 73.

Then, the main CPU 71 executes a second reel symbol random determination table selection process (S15). In this second reel symbol random determination table selection process, Type (Type A, Type B, or Type C) of the symbol random determination table for the second reel, which is referred to when a later-described second reel symbol random determination process (S16) is executed, is selected with reference to the code number corresponding to to-be-stopped symbol on the first reel determined in the first reel symbol random determination process in S14 and the symbol random determination table selection table for the second reel (see FIG. 13). The information of the selected Type of the symbol random determination table for the second reel is stored in the RAM 73.

For example, when the to-be-stopped symbol on the first reel determined in the first reel symbol random determination process in S14 is “FIRE7” corresponding to the code number “0” of the first reel 101, the Type-C symbol random determination table for the second reel, which corresponds to the code number “0” in the symbol random determination table selection table for the second reel (see FIG. 13), is selected.

Then, the main CPU 71 executes a second reel symbol random determination process (S16). In this second reel symbol random determination process, based on the probability (WEIGHT) defined by the Type (Type A, Type B, or Type C) (see FIG. 11) of the symbol random determination table for the second reel selected in the second reel symbol random determination table selection process in S15, one to-be-stopped symbol to be rearranged in the middle stage (on the payline) of the display window 150 in regard to the second reel 102 is randomly determined.

For example, when the Type of the symbol random determination table for the second reel selected in the second reel symbol random determination table selection process in S15 is Type C, the Type-C symbol random determination table for the second reel shown in FIG. 11 is referred to. When the code number “0” is selected at the random determination probability of 30/119 for the second reel 102, “RED7” corresponding to the code number “0” of the second reel 102 is selected as a to-be-stopped symbol to be rearranged in the middle stage of the display window 150 (on the payline).

The main CPU 71 stores the determined to-be-stopped symbol of the second reel 102 in the symbol storing area in the RAM 73.

Then, the main CPU 71 executes a third reel symbol random determination table selection process (S17). In this third reel symbol random determination table selection process, Type (Type A, Type B, or Type C) of the symbol random determination table for the third reel, which is referred to when a later-described third reel symbol random determination process (S18) is executed, is selected with reference to the code number corresponding to the to-be-stopped symbol on the second reel determined in the second reel symbol random determination process in S16 and the symbol random determination table selection table for the third reel (see FIG. 14). The information of the selected Type of the symbol random determination table for the third reel is stored in the RAM 73.

For example, when the to-be-stopped symbol on the second reel determined in the second reel symbol random determination process in S16 is “FIRE7” corresponding to the code number “0” of the second reel 102, the Type-C symbol random determination table for the third reel, which corresponds to the code number “0” in the symbol random determination table selection table for the third reel (see FIG. 14), is selected.

Then, the main CPU 71 executes a third reel symbol random determination process (S18). In this third reel symbol random determination process, based on the probability (WEIGHT) defined by the Type (Type A, Type B, or Type C) (see FIG. 12) of the symbol random determination table for the third reel selected in the third reel symbol random determination table selection process in S17, one to-be-stopped symbol to be rearranged in the middle stage (on the payline) of the display window 150 in regard to the third reel 103 is randomly determined.

For example, when the Type of the symbol random determination table for the third reel selected in the third reel symbol random determination table selection process in S17 is Type C, the Type-C symbol random determination table for the third reel shown in FIG. 12 is referred to. When the code number “0” is selected at the random determination probability of 10/229 for the third reel 103, “FIRE7” corresponding to the code number “0” of the third reel 103 is selected as a to-be-stopped symbol to be rearranged in the middle stage of the display window 150 (on the payline).

The main CPU 71 stores the determined to-be-stopped symbol of the third reel 103 in the symbol storing area in the RAM 73.

Then, the main CPU 71 executes an effect contents determination process (S19). The main CPU 71 extracts an effect-use random number and randomly selects one of a plurality of predetermined effect contents.

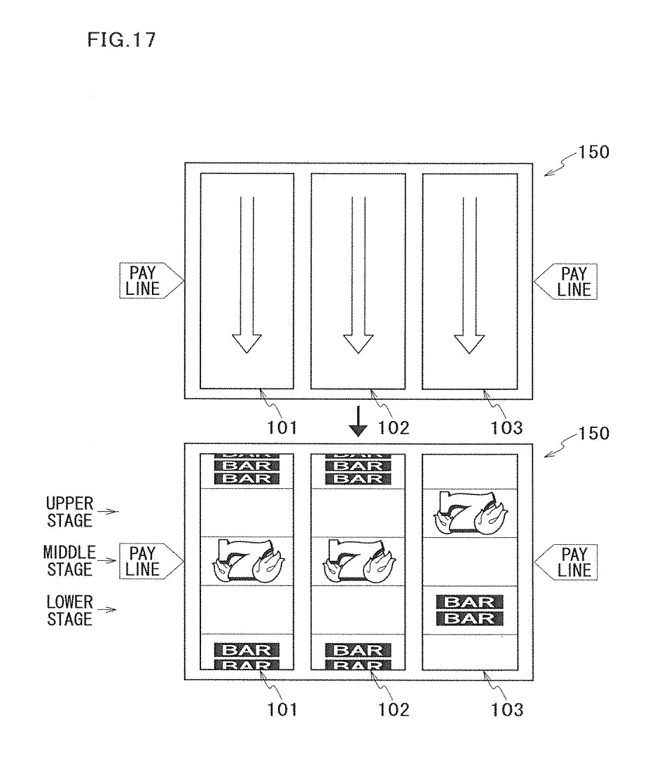

Then, the main CPU 71 executes a symbol display control process (S20). In this symbol display control process, as shown in FIG. 17, the scroll of the first reel 101, the second reel 102, and the third reel 103 starts, and after a predetermined time elapses, the to-be-stopped symbol in regard to the first reel 101 selected in the first reel symbol random determination process in S14 stops in the middle stage of the display window 150 (on the payline). Subsequently, in regard to the second reel 102, the to-be-stopped symbol determined in the second reel symbol random determination process in S16 is rearranged in the middle stage of the display window 150 (on the payline). Furthermore, in regard to the third reel 103, the to-be-stopped symbol determined in the third reel symbol random determination process in S18 is rearranged in the middle stage of the display window 150 (on the payline). As such, the to-be-stopped symbols corresponding to the first reel 101 to third reel 103 stop one by one in the middle stage of the display window 150 (on the payline). That is, 9 symbols including the to-be-stopped symbols are displayed in the display window 150 (in the upper stage, the middle stage, and the lower stage). For example, when the to-be-stopped symbol on the first reel 101 is “FIRE7”, the to-be-stopped symbol on the second reel 102 is “FIRE7”, and the to-be-stopped symbol on the third reel 103 is “BLANK”, “FIRE7”, “FIRE7”, and “BLANK” are rearranged in the middle stage of the display window 150 (on the payline) as shown in FIG. 17.

Then, the main CPU 71 executes a payout amount determination process (S21). In this process, payout is determined based on a symbol combination displayed on the payline with reference to the symbol combination table (see FIG. 9) stored in the RAM 73 and the value (1BET, 2BET, or 3BET) of the bet counter, and the payout is stored in the payout amount storage area provided in the RAM 73. For example, when the value of the bet counter is “3” and the symbol combination displayed on the payline is three “3BAR”, “60” credits are determined as the payout with reference to the symbol combination table shown in FIG. 9 and stored in the payout amount storage area in the RAM 73.

When the value of the bet counter is “3” (MAXBET) and the symbol combination displayed on the payline is three “FIRE7”, progressive payout is awarded. To be more specific, the value of a progressive payout counter (described later) stored in the RAM 73 is awarded as the progressive payout. The value of the progressive payout counter is calculated in such a way that, in a later-described JP increment process in S52, a value calculated by multiplying the value of the bet counter by an increment rate (0.01) is accumulatively added to the initial value of 1000 in each game play. When the progressive payout is won, the value of the progressive payout counter is stored in the payout amount storage area of the RAM 73. Furthermore, when the progressive payout is won, a message which notifies that the progressive payout has been awarded is displayed. To be more specific, messages “CONGRATULATIONS !”, “PROGRESSIVE WIN”, and “XXXXXXXX CREDITS” are displayed on the upper image display panel 131.

Then a payout process is executed (S22). The main CPU 71 adds the value stored in the payout amount storage area to the value of the credit counter in the RAM 73. The routine then proceeds to S12.

(Bet/Start-Check Process)

Now the bet/start-check process will be described with reference to FIG. 16.

To begin with, the main CPU 71 determines whether credit data has been received from the PTS device 700 (S41). The credit data is sent from the PTS device 700 to the main CPU 71, for example, when the IC card is inserted into the card insertion slot and when the bill entry 60 receives a genuine bill.

When the credit data is received (S41: YES), the main CPU 71 adds the amount indicated by the received credit data to the value of the credit counter (S42).

After the step S42 or when determining in S41 that no credit data is received (S41: NO), the main CPU 71 determines whether or not the value stored in the credit counter is 0 (S43). When determining that the value of the credit counter is 0 (S43: YES), the main CPU 71 goes back to S41.

When the main CPU 71 determines that the value of the credit counter is not 0 (S43: NO), the main CPU 71 permits operation acceptance of the BET buttons (1-BET button 34, 2-BET button 35, and 3-BET button 36) (S44).

Then the main CPU 71 determines whether an operation of the BET button is detected (S45). When an operation of the bet button by a player is detected by the bet switch (1-BET switch 34S, 2-BET switch 35S, or 3-BET switch 36S), the main CPU 71 performs addition to the value of the bet counter in the RAM 73, based on the type of the BET button (S46).

Subsequently, the main CPU 71 determines whether the value of the bet counter is at the maximum (S47). When determining that the value of the bet counter is at the maximum (S47: YES), the main CPU 71 prohibits the update of the value of the bet counter (S48). After S48, when determining in S47 that the value of the bet counter is not at the maximum (S47: NO), the main CPU 71 enables operation of the spin button 46 (S49).

After S49, the main CPU 71 determines whether an operation of the spin button 46 is detected (S50). When the main CPU 71 determines that an operation of the spin button 46 is not detected (S50: NO), the routine proceeds to S41.

In the meanwhile, when the main CPU 71 determines that operation of the spin button 46 is detected (S50: YES), the main CPU 71 subtracts the value of the bet counter calculated in S46 from the value of the credit counter (S51).

The main CPU 71 then executes a JP increment process (S52). In the JP increment process, as the resource of the progressive payout, the value of the progressive payout counter in the RAM 73 is incremented by a value calculated by multiplying the value of the bet counter calculated in S46 by an increment rate (0.01 but may be optionally set) set in the present embodiment. For example, when the value of the bet counter calculated in S46 is “3”, 3×0.01=0.03 credit is added to the value of the progressive payout counter. In the present embodiment, the initial value of the progressive payout counter is 1000 credits. Therefore, in the progressive payout counter, a value calculated by multiplying the value of the bet counter by the increment rate (0.01) is accumulatively added to the initial value of 1000 in each game play.

Then the bet/start-check process is terminated.

According to the arrangement above, a symbol random determination table, which is referred to when a symbol to be rearranged is selected from symbols on a reel to be rearranged next, is selected based on a symbol rearranged on a predetermined reel. As such, the probability of rearrangement of each symbol in a reel which is to be rearrangement after a predetermined reel is determined based on a symbol rearranged on the predetermined reel. With this arrangement, the probability of rearrangement of a predetermined symbol on the display is changed in accordance with the game progress, with the result that monotonousness in the game play is resolved.

In addition to the above, the probabilities of rearrangement of symbols on all reels are determined based on the symbols on the reel rearranged in the directly preceding step. With this, the probabilities of rearrangement of all symbols on the display device is changed in accordance with the game progress, with the result that monotonousness in the game play is resolved.

### Outline of Second Embodiment: P15-0257

The descriptions below may use the same reference numerals as in the embodiment above, but the embodiment below will describe arrangements different from those in the embodiment above.

As a typical gaming machine, a slot machine is arranged such that, as a player presses a button on a control panel, reels on which symbols are provided are scrolled and then stopped, with the result that the symbols are rearranged. In such a slot machine, a benefit such as a payout is awarded to a player based on a combination of rearranged symbols.

A type of the slot machines is arranged such that, after each reel is rotated and stopped, symbols are rearranged at equal probabilities. For example, when 22 symbols are arranged on a reel, a probability of rearrangement of each of 22 symbols is 1/22. In the meanwhile, another type of the slot machines is arranged such that, after each reel is scrolled and stopped, symbols are rearranged at not equal but different probabilities. In such a slot machine, for example, when 22 symbols are arranged on a reel, a probability of rearrangement of each symbol is different between the symbols, e.g., a probability of rearrangement of a symbol A is 1/10 whereas a probability of rearrangement of a symbol B is 1/50, and a random determination table in which a probability of rearrangement is associated with each symbol is provided (see Japanese Unexamined Patent Publication No. 2013-153875).

In the slot machine above, the random determination table in which a probability of rearrangement is associated with symbols of each reel is typically identical between games, with the result that game play may be monotonous.

An object of the present invention is to provide a gaming machine which makes it possible to avoid monotonous game play.

The present invention relates to a gaming machine including: a display device configured to display a game result by rearranging reels on which symbols are arranged;

a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
a process of selecting, from the symbol random determination tables, a symbol random determination table which is referred to in a symbol random determination process of selecting a symbol to be rearranged from symbols on an N-th reel to be rearranged (N is an integer 3 or larger), with reference to a combination of symbols which are rearranged on reels which are fewer in number than N and rearranged before the N-th reel and with reference to the symbol random determination table selection table; and
a symbol random determination process of, based on the symbol random determination table selected in the preceding process, randomly selecting a symbol from the symbols on the N-th reel to be rearranged.

According to the arrangement above, the symbol random determination table which is referred to when symbols rearranged on the N-th reel are randomly selected is selected based on a combination of symbols rearranged on the reels which are fewer in number than N and rearranged before the N-th reel. This makes it possible to change the probability of rearrangement of a symbol on the N-th reel in association with a combination of symbols on each of the reels having already been confirmed to be rearranged, with the result that the monotonous game play is avoided.

The present invention relates to a gaming machine including: a display device configured to display a game result by rearranging N (N is three or larger) or more reels on which symbols are arranged;

a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
(1A) a first symbol random determination process of, when a game starts, based on a predetermined symbol random determination table, randomly selecting each symbol to be rearranged from symbols on first to (N−1)-th reels to be rearranged;
(1B) a process of selecting one of the symbol random determination tables with reference to a combination of the symbols selected in the first symbol random determination process and the symbol random determination table selection table;
(1C) a second symbol random determination process of randomly selecting a symbol to be rearranged from symbols on the N-th reel to be rearranged, based on the symbol random determination table selected in the process (1B); and
(1D) a process of displaying the symbols selected in the first symbol random determination process and the second symbol random determination process by rearranging the first to N-th reels to be rearranged.

According to the arrangement above, in accordance with a combination of symbols rearranged on the first to (N−1)-th reels, a symbol random determination table which is referred to when a symbol rearranged on the N-th reel is randomly determined is selected. This makes it possible to change the probability of rearrangement of a symbol on the N-th reel in association with a combination of symbols rearranged on the first to (N−1)-th reels, with the result that the monotonous game play is avoided.

In the present invention, the above-described gaming machine is arranged such that, in the symbol random determination table selection table, a symbol random determination table corresponding to a combination of symbols including the predetermined symbol defines that the probability of rearrangement of the predetermined symbol is higher than the probability in a symbol random determination table corresponding to a combination of symbols not including the predetermined symbol.

According to the arrangement above, when a combination of symbols rearranged on the first to (N−1)-th reels include the predetermined symbol, the probability of rearrangement of the predetermined symbol on the N-th reel is high, with the result that the monotonousness in the game play is avoided.

In the present invention, the above-described gaming machine is arranged such that,

when a combination of the symbols determined in the first symbol random determination process in (1A) is a combination of symbols including the predetermined symbol, in the process (1B), the symbol random determination table selection table in which the probability of rearrangement of the predetermined symbol in the symbol random determination table corresponding to a combination of symbols including the predetermined symbol is higher than the probability of rearrangement of the predetermined symbol in the symbol random determination table corresponding to a combination of symbols not including the predetermined symbol is selected.

According to the arrangement above, when a combination of symbols rearranged on the first to (N−1)-th reels include the predetermined symbol, the probability of rearrangement of the predetermined symbol on the N-th reel is high, with the result that the monotonousness in the game play is avoided.

In the present invention, the above-described gaming machine is arranged such that,

the display displays a game result by a combination of symbols formed by rearranging N (N is 3 or larger) reels, on which symbols are provided, in a matrix-shaped display areas, and
in the symbol random determination table selection table, a symbol random determination table corresponding to a combination of symbols including the predetermined symbol is a symbol random determination table which defines that the probability of rearrangement of the predetermined symbol in a predetermined display area is higher than the probability in a symbol random determination table corresponding to a combination of symbols not including the predetermined symbol.

According to the arrangement above, when a combination of symbols rearranged on the first to (N−1)-th reels includes a predetermined symbol, the probability of rearrangement of the predetermined symbol in a predetermined display area is increased for a symbol rearranged on the N-th reel. With this, the predetermined symbol is more likely to be displayed in the predetermined display area of the display, and hence monotonous game play is avoided.

The present invention relates to a gaming machine including: a display device configured to display symbols by rearranging reels on which symbols are arranged;

a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
selecting, from the symbol random determination tables, a symbol random determination table which is referred to in a symbol random determination process of selecting a symbol to be rearranged from symbols on a predetermined-number-th reel to be rearranged, with reference to a combination of symbols rearranged on the first to ((predetermined number)−1)-th reels and the symbol random determination table selection table; and
based on the symbol random determination table selected in the process above, randomly selecting a symbol to be rearranged, from the symbols on the predetermined-number-th reel to be rearranged.

According to the arrangement above, in accordance with a combination of symbols rearranged on the first to ((predetermined number)−1)-th reels, a symbol random determination table which is referred to when a symbol rearranged on the predetermined-number-th reel is randomly determined is selected. This makes it possible to change the probability of rearrangement of a symbol on the predetermined-number-th reel in association with a combination of symbols rearranged on the previous reels, with the result that the monotonous game play is avoided.

A gaming machine which makes it possible to avoid monotonous game play is provided.

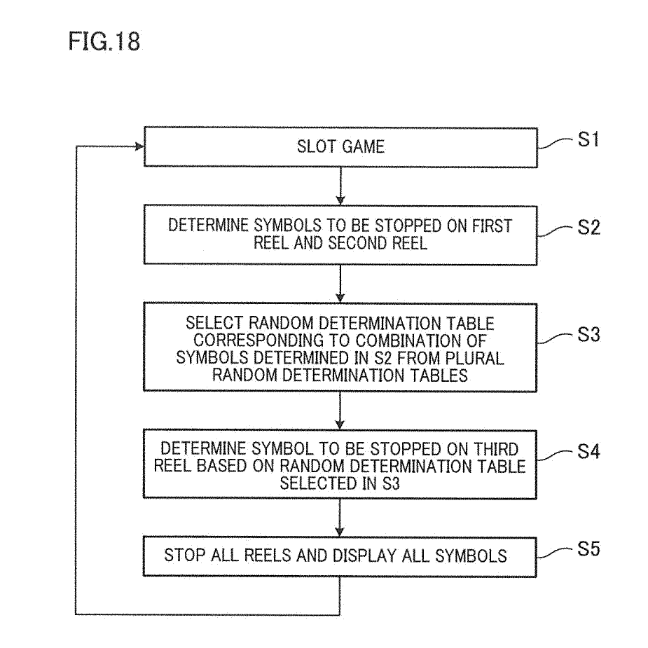

The following will describe an embodiment of the present invention with reference to the drawings. FIG. 18 shows the outline of a game flow of a slot machine according to the embodiment of the present invention. As shown in FIG. 18, the slot machine of the embodiment of the present invention executes a slot game.

The slot games are of a line type (Left to Right). The slot games employ mechanical reels. The reels are formed of three reels. That is to say, the reels are formed of a first reel, a second reel, and a third reel. Furthermore, a single payline is set.

In the slot game, based on a symbol random determination table in which a probability of rearrangement of symbols lined up on three reels in a display window is associated with each symbol, a symbol random determination process is carried out to randomly determine symbols to be rearranged in the display window, the determined symbols are rearranged in the display window, and a benefit is awarded based on a combination of symbols rearranged on a payline (equivalent to an arrangement pattern).

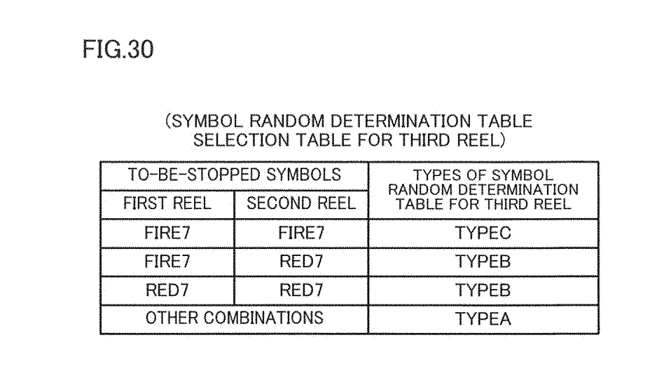

To be more specific, as shown in FIG. 18, when the slot game starts (S1), symbols stopping at the first reel are randomly determined based on a symbol random determination table for the first reel, and symbols stopping at the second reel are randomly determined based on a symbol random determination table for the second reel (S2). Subsequently, a random determination table corresponding to a combination of the symbols stopping at the first reel and the symbols stopping at the second reel determined in S2 is selected from plural random determination tables (with reference to a later-described symbol random determination table selection table for the third reel shown in FIG. 30) (S3). Subsequently, symbols stopping at the third reel are determined based on the random determination table selected in S3 (S4). Thereafter, all reels stop in the display window and all symbols are displayed on the display window (rearranged) (S5).

### Definitions

The slot game in the present embodiment is run by the slot machine 1. The slot game is a game of rearranging symbols. The rearrangement of symbols in the slot game is carried out by a mechanical reel unit (equivalent to a display device). In the slot game, on condition that a gaming value is bet, symbols are rearranged in the display window by the mechanical reel unit, and a payout is awarded according to the rearranged symbols. In addition to the above, for example, a free game which does not require betting of a gaming value, a game in which a payout amount and a payout rate are higher than those in the normal game, a mini game different from the normal game, or a game in which a predetermined condition is more probable to be established as compared to the normal game may be executed.

The symbols collectively mean “FIRE7”, “RED7”, “3BAR”, “2BAR”, “1BAR”, and “BLANK”.

The gaming value is electrically valuable information such as electronic money and the like. It is to be noted that the gaming value in the disclosure is not limited to these, and for example a gaming medium such as a medal, a token, a coin, a ticket or the like can be adopted. The ticket is not particularly limited, and for example, a ticket having data of credit amount and the like in the form of bar code. Alternatively, the gaming value may be a game point not including valuable information.

The term “rearrangement” indicates that the symbols are rearranged after the arrangement of the symbols is dismissed. Arrangement means a state where the symbols can be visually confirmed by a player. More specifically, “rearrangement” is a state in which, after the symbols on the reels are variably displayed as the reels rotate, the variable display of the symbols stops as the rotation of the reels stops, and the symbols stop in the display window.

(Functional Flow)

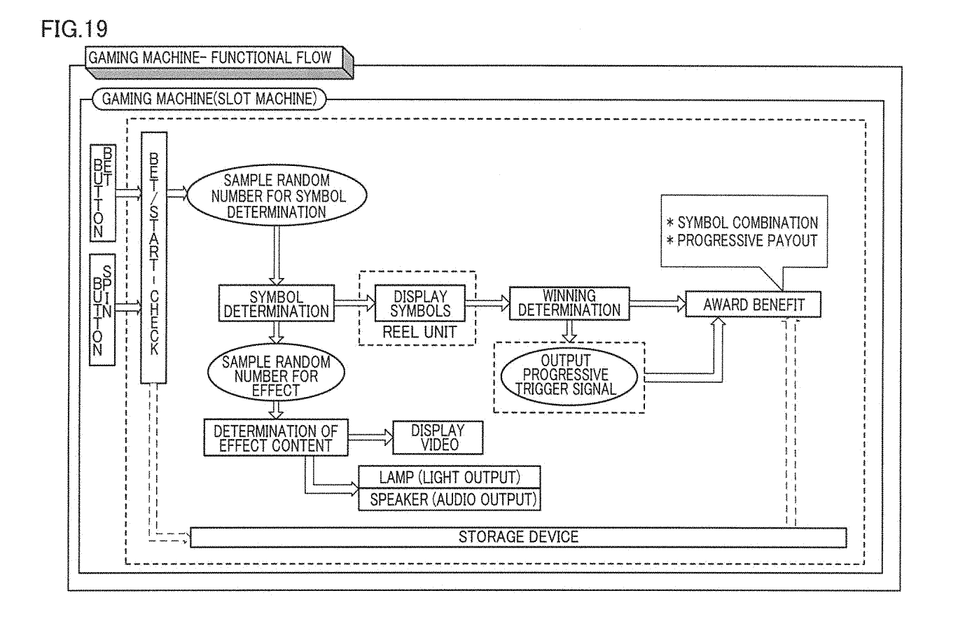

The following describes basic functions of the slot machine related to the embodiment of the present invention, with reference to FIG. 19. FIG. 19 shows the functional flow of the slot machine of the embodiment of the present invention.

<Bet/Start-Check>

First, the slot machine checks whether or not a BET button has been pressed by a player, and subsequently checks whether or not a spin button has been pressed by the player.

<Symbol Determination>

Subsequently, when the spin button is pressed by the player, the slot machine extracts a random number for symbol determination, and determines, with reference to the symbol random determination table selected in the symbol random determination table random determination, symbols to be displayed (rearranged) for the player at the time of stopping the scroll of the reel, for respective reels.

<Reel Control>

Thereafter, the slot machine starts the rotation of each reel and stops the rotation of each reel so that the determined symbols are displayed for the player (symbol display).

<Winning Determination>

Subsequently, as the rotation of each reel is stopped, the slot machine determines whether the combination of the symbols displayed for the player is a combination related to winning.

<Awarding Benefit>

When the combination of the symbols displayed for the player is a combination related to winning, the slot machine offers, to the player, benefit according to the type of the combination. For example, when a combination of symbols related to awarding of a credit is displayed, the slot machine awards credits to the player, the amount of which corresponds to the combination of the symbols.

In addition to the above, the slot machine may accumulatively add a part of a bet amount to progressive payout stored in the storage device, each time the unit game is executed. When progressive payout is employed, the slot machine awards the progressive payout accumulatively stored in the storage device to the player, when a progressive trigger condition is established. The progressive (jackpot) is a function of accumulating at least one of coins betted by a player at a slot machine (or slot machines) in the progressive payout and awarding the accumulated progressive payout to a slot machine in which a progressive trigger is established. When the progressive payout is accumulated by plural slot machines, an amount (accumulative amount) accumulated to the progressive payout is calculated and transmitted to an external controller each time the game is executed. The external controller adds the accumulative amount sent from each slot machine to the progressive payout.

The slot machine may have other benefits such as a mystery bonus and insurance. In the mystery bonus, a predetermined number of coins are paid out when a winning is achieved in dedicated random determination. When a spin button is pressed, the slot machine samples a random number for the mystery bonus, and whether a mystery bonus trigger is established is randomly determined.

The insurance is a function for saving the player when the free game is not executed for a long period of time. Whether the insurance is activated or not is freely determined by an administrator of the slot machine. When the insurance is activated, a predetermined insurance activation amount must be paid. When the insurance is activated, the slot machine starts to count the number of plays of the game. When the counted number of plays reaches a predetermined number without a large amount of payout, the slot machine pays out coins, the amount of which has been set for the insurance.

<Determination of Effect>

The slot machine produces an effect by displaying an image on a display, outputting light from a lamp, and outputting sound from a speaker. The slot machine extracts an effect-use random number and determines the contents of the effect based on randomly determined symbols or the like.

[Overall Structure of Game System]

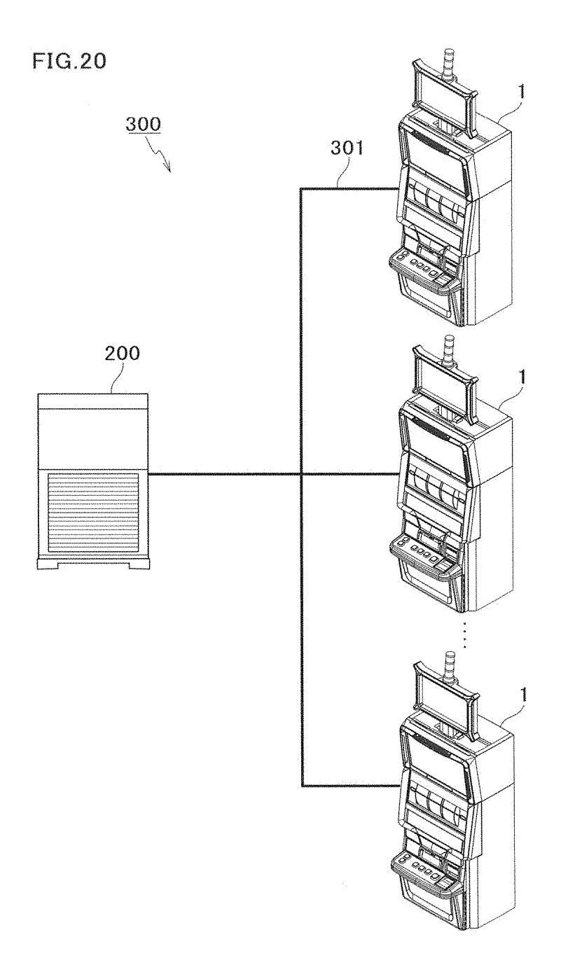

The basic functions of the slot machine have been described as above. Now, referring to FIG. 20, a game system including the slot machines will be described. FIG. 20 shows the game system including the slot machines of the embodiment of the present invention.

The game system 300 includes the slot machines 1 and an external controller 200 connected to each slot machine 1 over communication lines 301.

The external controller 200 is configured to control the slot machines 1. In the embodiment of the present invention, the external controller 200 is a so-called hall server installed in a gaming facility where the plurality of slot machines 1 are provided. Each of the slot machines 1 has a unique identification number, and the external controller 200 identifies which one of the slot machines 1 transmitted data, by referring to the identification number. Further, when transmitting data from the external controller 200 to any of the slot machines 1, the identification number is used for designating the transmission destination.

The game system 300 may be constructed in a single gaming facility such as a casino where various games are playable or may be constructed for a plurality of gaming facilities. Further, when the game system 300 is constructed in a single gaming facility, the gaming system may be constructed in each floor or section of the gaming facility. The communication line 301 may be a wired or wireless line, and can adopt a dedicated line, an exchange line, or the like.

The game system 300 is of a network type in which the slot machines 1 are connected with the external controller 200 by a communication line 301, but the game system 300 may be of a standalone type in which each slot machine 1 independently executes a game.

[Overall Structure of Slot Machine]

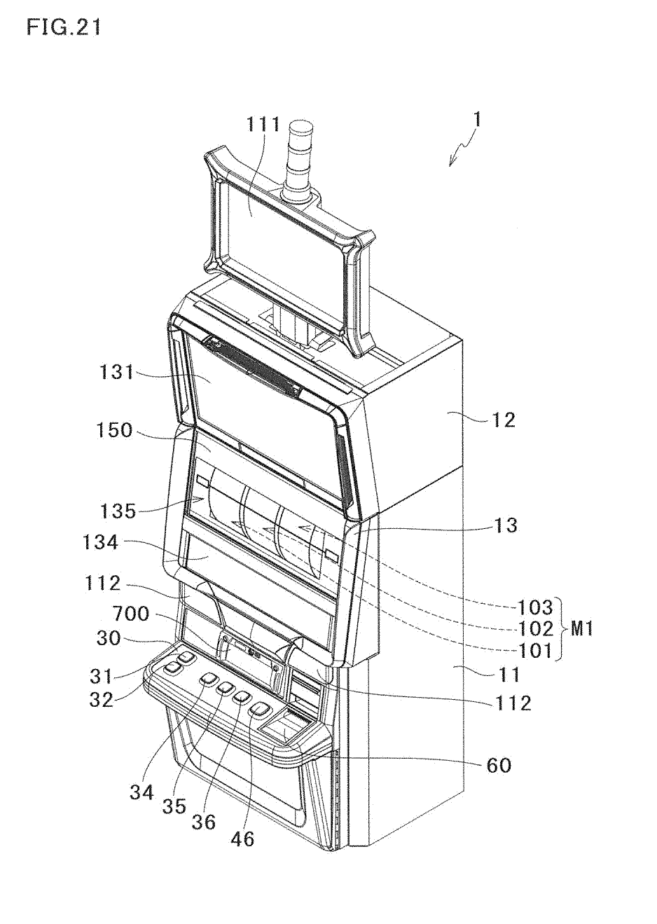

Now, referring to FIG. 21, the overall structure of the slot machine 1 will be described. FIG. 21 shows the overall structure of the slot machine of the embodiment of the present invention.

Electrically valuable information such as electronic money is used as a gaming value in the slot machine 1. It is to be noted that the gaming value is not limited to this, and for example a coin, a medal, a token, a ticket with a bar code and the like can be adopted.

The slot machine 1 includes a cabinet 11, a top box 12 installed on the upper side of the cabinet 11, and a main door 13 provided at the front surface of the cabinet 11. Above the top box 12, a digital signage 111 is provided.

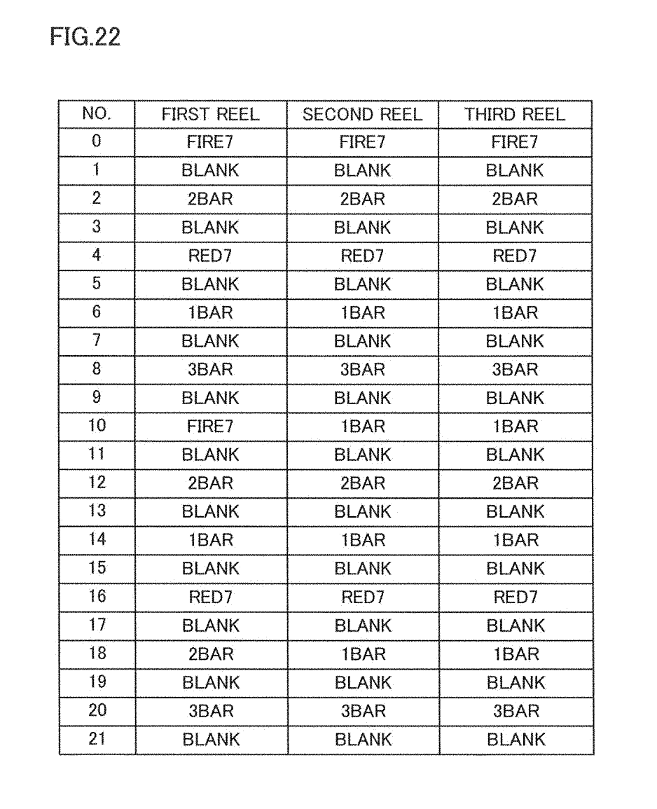

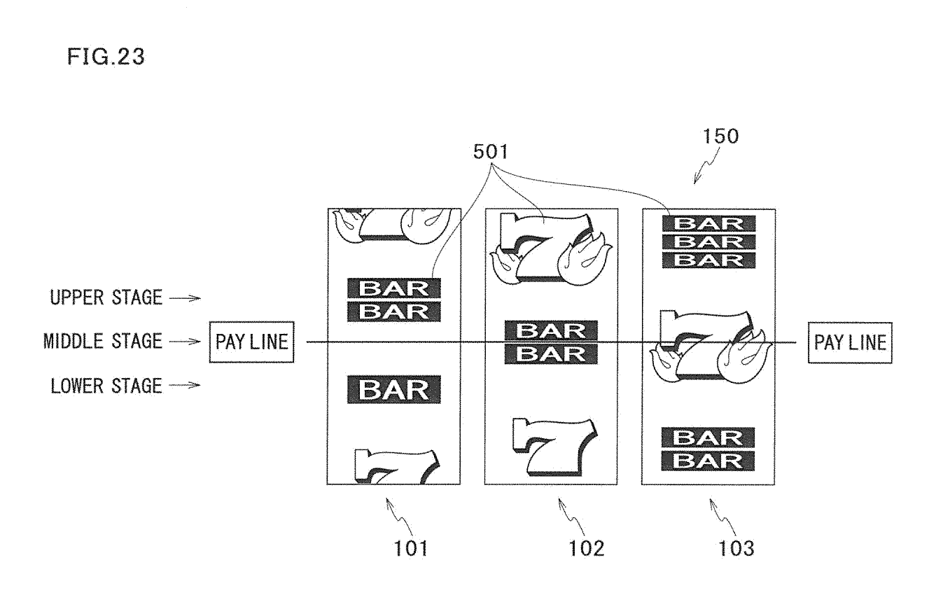

The main door 13 is provided with a reel unit M1 (corresponding to a symbol display device) constituted by three reels 101, 102, and 103. A reel cover 135 is provided in front of the reel unit M1. On the front surface of the reel cover 135, a liquid crystal display device 134 by which a game status is reported to the player and a transparent panel are provided. This liquid crystal display device 134 is provided with a touch panel 137. The reel cover 135 has a display window 150 (equivalent to a display device) at its central portion. In the display window 150, one symbol 501 is provided in each of the upper stage, the middle stage, and the lower stage of each of the reels 101, 102, and 103 (see FIG. 23). To put it differently, 9 symbols 501 forming a 3 by 3 matrix are visibly displayed in the display window 150. On the outer circumferential surface of each of the reels 101, 102, and 103, 22 symbols are depicted (see FIG. 22). These 22 symbols 501 are lined up along the rotational direction of the reels 101, 102, and 103 to form a symbol array. Each of the symbol arrays is a combination of “FIRE7”, “RED7”, “3BAR”, “2BAR”, “1BAR”, and “BLANK”. To the main door 13 is provided a speaker 112.

As shown in FIG. 23, a payline for result determination of symbols 501 rearranged in the display window 150 is set in the slot machine 1. In the present embodiment, one payline is formed at the middle stage of the display window 150 as shown in FIG. 23. Alternatively, plural paylines may be provided and each payline may be activated upon selection by a player.

As shown in FIG. 23, the reel unit M1 rearranges the symbols 501 on the display window 150 by drivingly rotating the reels 101, 102, and 103 each having the symbols 501 on the outer circumferential surface. In the descriptions below, the reels may be referred to as a first reel 101, a second reel 102, and a third reel 103 from the left end in front elevation.

On the inner circumferential side of each of the reels 101, 102, and 103 arranged as above, a backlight unit (not illustrated) is provided. The backlight unit emits illumination light from the inner circumferential side of the reels 101, 102, and 103 to the outer circumferential surface of the reels and is arranged so that the illumination light passing through the outer circumferential surface of the reels is seen from the outside of the display window 150. The backlight unit is configured to be able to change the amount of illumination light in multiple stages. The degree of freedom in the effects using illumination light is therefore high. Furthermore, each backlight unit is able to emit light in multiple colors, and to illuminate the symbols individually with the illumination light.

It should be noted that the present embodiment deals with a case where the slot machine 1 employs the reel unit M1 in the form of mechanical reels; however, the slot machine 1 of the present invention may adopt video reels that display simulated reels, or adopt a combination of the video reels and the mechanical reels.

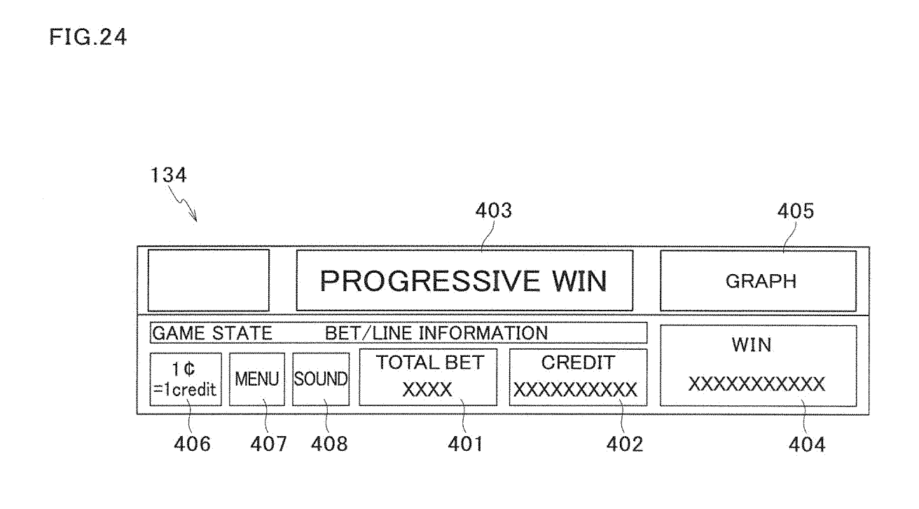

As shown in FIG. 24, on the liquid crystal display device 134 is displayed meters indicating the conditions of the game. For example, a total bet meter 401 displays “Total Bets”. The numerical value is re-calculated at every game play. The credit meter 402 indicates the total credit amount at the time. The default value is 0. The numerical value is increased or decreased according to the gaming value input, the bet, and the game result. A game message area 403 indicates a message explaining the current gaming status. The win meter 404 indicates the total credit amount of the payout having been won.

The liquid crystal display device 134 is provided with a graph touch area 405, a denomination indicator 406, a menu touch area 407, and a sound volume switching touch area 408. When touched by the player, the touch area 405 displays, in the form of graphs, the change of the obtained payout amount, the total number of game play, and the total obtained credit amount on the upper image display panel 131. As the graph touch area 405 is touched, three types of graph images, i.e., line-graph, bar-graph, and block-graph are displayed in order. The denomination indicator 406 displays current denomination. When the menu touch area 407 is touched by the player, the upper image display panel 131 displays the first page of the HELP screen. The sound volume switching touch area 408 is used for switching the game sound volume in three stages. Each time the sound volume switching touch area 408 is touched by the player, the game sound volume is switched such that, for example, from low to middle to high to small to middle.

An upper image display panel 131 is provided at the front surface of the top box 12. The upper image display panel 131 includes a liquid crystal panel, and forms the display. The upper image display panel 131 displays images related to effects and images showing introduction of the game contents and explanation of the game rules.

Below the reel unit M1 are provided a control panel 30 having various buttons, a PTS device 700, and a bill entry 60.

The bill entry 60 validates bills and receives genuine bills into the cabinet 11. The bill entry 60 is electrically connected to the PTS device 700, and when a legitimate bill is received, transmits to the PTS device 700 an input signal based on the value of the bill. The input signal includes information on credit data or the like related to the received bill.

The PTS device 700 is a unit in which an LCD (liquid crystal display), a human body detection camera, a microphone, and the like are integrated. The human detection camera makes it possible to detect the presence of a player by the camera function. The microphone is used for the player's participation in a game by voice and the authentication of a player by voice recognition. Further, the PTS device 700 has a card insertion slot to which an IC card can be inserted. With this, the player is able to insert an IC card into the card insertion slot and use the credits stored in the IC card in the slot machine 1.

(Control Panel 30)

On the control panel 30, a HELP button 31 and a CASHOUT button 32 are arranged in the left side area, a 1-BET button 34, a 2-BET button 35, and a 3-BET button 36 are arranged in the middle area, and a spin button 46 is arranged in the lower stage on the left side area.

The HELP button 31 is pressed when, for example, it is unclear how to play a game. As the HELP button 31 is pressed, various help information is displayed on the upper image display panel 131. The CASHOUT button 32 is an operation button used when checking out credits reserved in the slot machine 1 is discharged.

Each time the 1-BET button 34 is pressed, one of the credits currently owned by the player is betted. The 2-BET button 35 is used to start a game with two bets. The 3-bet button 36 is used to start a game with three bets. A gaming value corresponding to one bet can be optionally changed by setting the denomination.

The spin button 46 is used to start the rotation of the reels 101, 102, and 103.

(Symbol Array)

Now, with reference to FIG. 22, the arrays of the symbols 501 on the first reel 101, the second reel 102, and the third reel 103 of the slot machine 1 will be described.

A symbol table shown in FIG. 22 shows arrays of the symbols 501 displayed on the outer circumferential surfaces of the first reel 101, the second reel 102, and the third reel 103. To each of the first reel 101, the second reel 102, and the third reel 103 is assigned a symbol array including 22 symbols 501 respectively corresponding to code numbers 0 to 21.

As shown in FIG. 22, the types of the symbols include “FIRE7”, “RED7”, “3BAR”, “2BAR”, “1BAR”, and “BLANK”.

[Structures of Circuits Provided to Slot Machine]

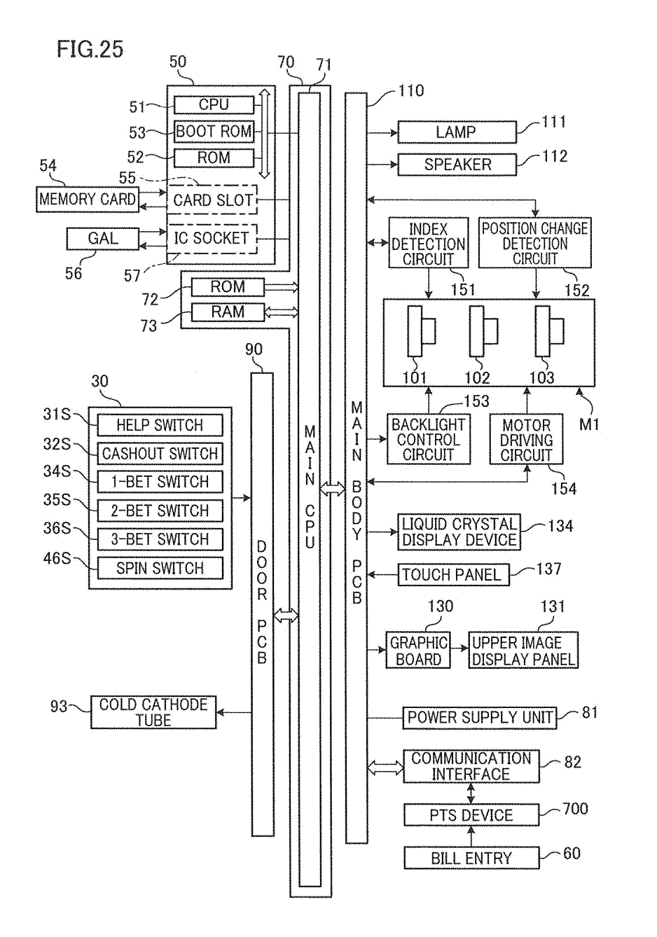

Now, referring to FIG. 25, the configuration of a circuit in the slot machine 1 will be described. FIG. 25 is a block diagram showing an internal structure of the slot machine of the embodiment of the present invention.

A gaming board 50 is provided with a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and an effect program for producing effects by images and sounds.

Further, the card slot 55 is configured so that the memory card 54 can be inserted thereinto and removed therefrom, and is connected to a motherboard 70 by an IDE bus. The type and contents of the game to be played on the slot machine 1 can be changed by drawing out the memory card 54 from the card slot 55, writing another game program into the memory card 54, and inserting the memory card 54 into the card slot 55.

The GAL 56 is a type of PLD (programmable logic device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like. The authentication program is a program (falsification check program) for authenticating the game program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 correspond to a storage device.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started.

The processor of the present invention includes the main CPU 71, the ROM 72, and the RAM 73 above and the memory card 54 storing the game program, and controls the slot machine by causing the main CPU 71 to execute the game program. Needless to say, the processor may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations when these programs are executed. Examples of the areas include: an area that stores counter which manages the number of game play, a bet amount, the credit amount, a payout value of each progressive payout, and the like; and an area that stores symbols (code numbers) randomly determined.

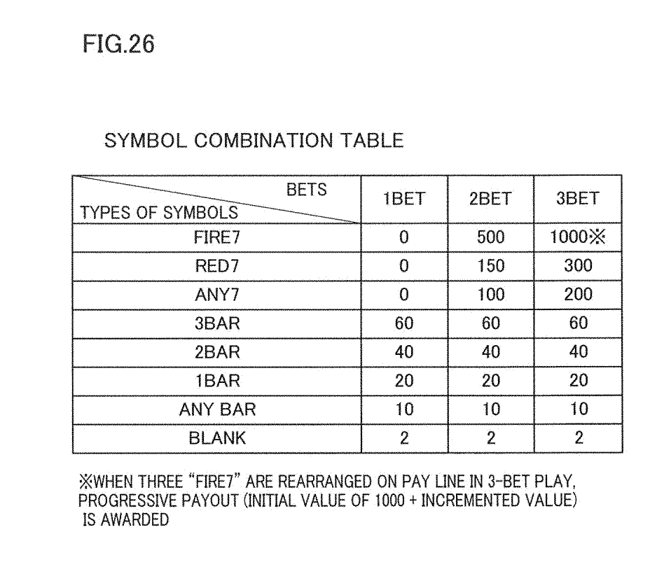

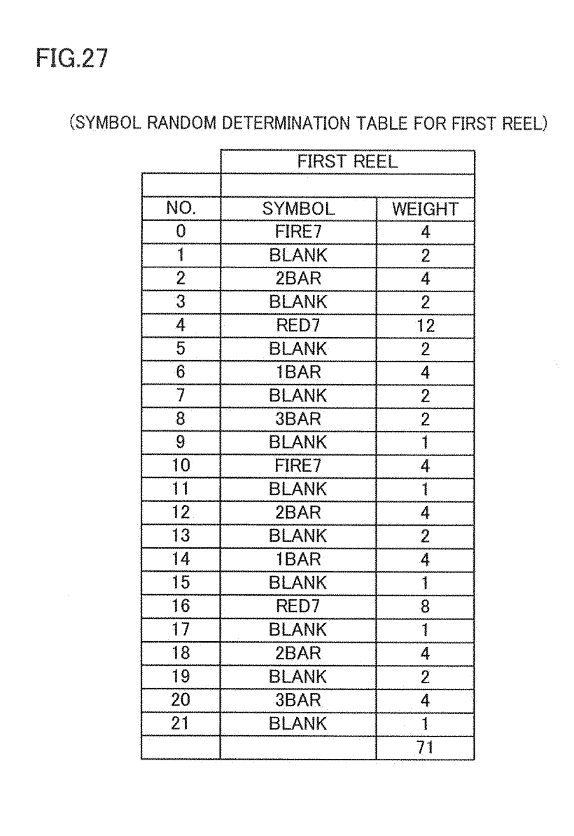

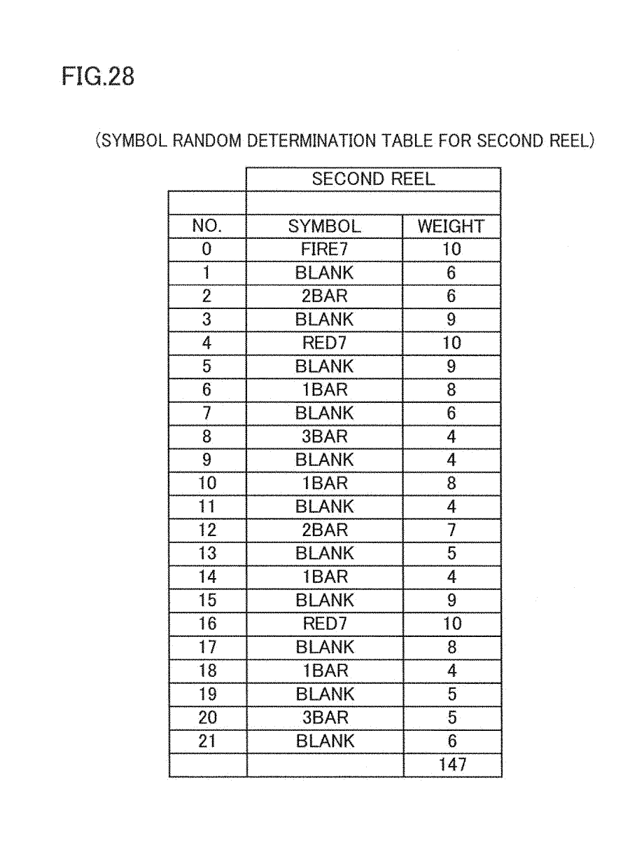

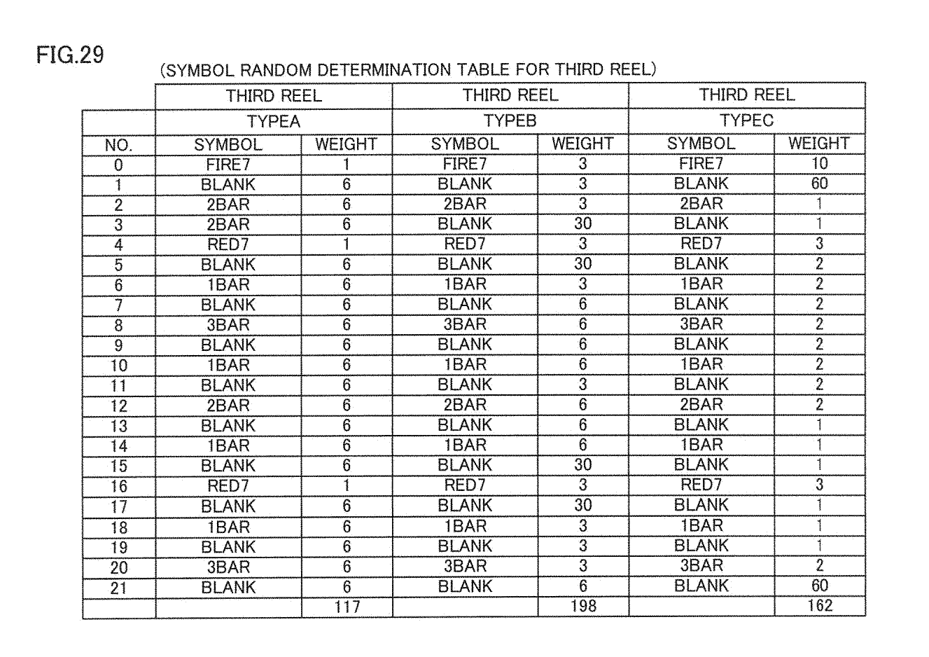

In addition to the above, the RAM 73 stores tables such as a symbol combination table (see FIG. 26), a symbol random determination table for the first reel (see FIG. 27), a symbol random determination table for the second reel (see FIG. 28), a symbol random determination table for the third reel (see FIG. 29), and a symbol random determination table selection table for the third reel (see FIG. 30).

The communication interface 82 is for communicating with the PTS device 700 and the external controller 200. The PTS device 700, upon reception of an input signal from the bill entry 60, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with the control panel 30, and a cold cathode tube 93.

The control panel 30 is provided with a HELP switch 31S, a CASHOUT switch 32S, a 1-BET switch 34S, a 2-BET switch 35S, a 3-BET switch 36S, and a spin switch 46S, correspondingly to the above-described buttons. Each of the switches outputs a signal to the main CPU 71 upon detection of press of the button corresponding thereto by the player.

The cold cathode tube 93 functions as a backlight installed on the rear face side of the upper image display panel 131, and lights up based on a control signal output from the main CPU 71.

The body PCB 110 is connected with a lamp 111, a speaker 112, a graphic board 130, the liquid crystal display device 134, a touch panel 137, an index detection circuit 151, a position change detection circuit 152, a backlight control circuit 153, and a motor driving circuit 154. The index detection circuit 151, the position change detection circuit 152, a backlight control circuit 153, and a motor driving circuit 154 are connected with the reel unit M1.

The lamp 111 turns on based on a control signal outputted from the main CPU 71. The speaker 112 outputs BGM sound or the like in accordance with a control signal output from the main CPU 71.

The graphic board 130 controls displaying of images on the upper image display panel 131 based on a control signal output from the main CPU 71. The graphic board 130 is provided with a VDP (video display processor) configured to generate image data, a video RAM configured to store the image data generated by the VDP, and the like. It is to be noted that the image data used for generating image data by the VDP is included in the game program that has been read from the memory card 54 and stored into the RAM 73.

The liquid crystal display device 134 displays an image based on a control signal output from the main CPU 71. The touch panel 137 detects a position on the liquid crystal display device 134 touched by a finger or the like of the player, and outputs a signal corresponding to the detected position to the main CPU 71.

The motor driving circuit 154 is connected to a stepper motor configured to rotate the reels 101, 102, and 103. Further, the motor driving circuit 154 includes an FPGA (Field Programmable Gate Array) and a driver. The FPGA is an electronic circuit such as a programmable LSI, and functions as a control circuit of the stepping motor. The driver functions as an amplifying circuit for pulses to be input to the stepping motor.

The index detection circuit 151 detects the positions of the rotating reels 101, 102, and 103 and is able to detect the step out of the reels 101, 102, and 103.

The position change detection circuit 152 is configured to detect a change in the stop position of the reels 101, 102, and 103 after the rotation of the reels 101, 102, and 103 is stopped. The position change detection circuit 152 detects a change in the stop positions of the reels 101, 102, and 103 when, for example, a stop position is changed to achieve a winning combination of the symbols 501 by an illicit way when no winning combination of the symbols 501 is achieved. The position change detection circuit 152 is configured to detect a change in the stop position of the reels 101, 102, and 103, for example, by detecting not-shown fins which is arranged on the inner sides of the reels 101, 102, and 103 at predetermined intervals.

It should be noted that the method of exciting the stepper motor is not particularly limited, and 1-2 phase excitation system or a 2 phase excitation system are adoptable. Further, a DC motor may be adopted in place of the stepper motor. In cases of adopting a DC motor, the main body PCB 110 is connected to an error counter, a D/A converter, a servo amplifier in this order, and the DC motor is connected to the servo amplifier. Further, the rotational position of the DC motor is detected by the rotary encoder, and the rotary encoder supplies the current rotational position of the DC motor in the form of data to the error counter.

The backlight control circuit 153 is connected to the backlight units to individually supply driving power thereto. Upon receiving an instruction from the main CPU 71, the backlight control circuit 153 changes the amount of light emitted in multiple stages. The five backlight units provided on the inner circumferential surfaces of the reels 101, 102, and 103 are able to individually illuminate 9 symbols 501 having stopped on the display window 150 by means of the backlight control circuit 153.

(Symbol Combination Table)

Now, symbol combination tables will be described with reference to FIG. 26. FIG. 26 shows a symbol combination table in the slot machine of the embodiment of the present invention.

The symbol combination table defines payouts for bet amounts and symbol combinations achieving winning (WIN). In the slot machine 1, the rotational scroll of the reels 101, 102, and 103 is stopped, and when a combination of three symbols displayed (rearranged) on a payline corresponds to a symbol combination defined in the symbol combination table, winning is achieved. In accordance with the type of winning, a benefit will be given to the player in the form of awarding payout and the like. It is noted that winning is not established (i.e. the game is lost) when the combination of symbols displayed (rearranged) on the payline does not match with any of the combinations of symbols specified by the symbol combination table.

Basically, winning is achieved when three symbols of the following types are displayed on a payline: “FIRE7”, “RED7”, “3BAR”, “2BAR”, “1BAR”, and “BLANK”. Furthermore, winning is achieved as “ANY7” when a symbol combination including “FIRE7” and “RED7” is established. Winning as “ANYBAR” is also achieved when a symbol combination including “3BAR”, “2BAR”, and “1BAR” is established. When the game is played with one bet, no payout is awarded for “FIRE7”, “RED7”, and “ANY7”. When the game is played with three bets, progressive payout (initial value 1000+incremented amount) is awarded when three “FIRE7” are rearranged on a payline.

(Symbol Random Determination Table for First Reel)

Now, the symbol random determination table for the first reel will be described with reference to FIG. 27. In the present embodiment, the random determination table for the first reel is a random determination table defining probabilities of 22 symbols regarding the first reel 101, which is referred to in a main control process which will be described later.

In the symbol random determination table for the first reel, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in the symbol random determination table for the first reel shown in FIG. 27, “FIRE7” of the first reel 101 corresponding to the code number “0” is rearranged in the middle stage of the display window 150 (on the payline) at a probability of 4/71. “BLANK” of the first reel 101 corresponding to the code number “1” is rearranged in the middle stage of the display window 150 (on the payline) at a probability of 2/71. “RED7” of the first reel 101 corresponding to the code number “4” is rearranged in the middle stage of the display window 150 (on the payline) at a probability of 12/71.

(Symbol Random Determination Table for Second Reel)

Now, the symbol random determination table for the second reel will be described with reference to FIG. 28. In the present embodiment, the random determination table for the second reel is a random determination table defining probabilities of 22 symbols regarding the second reel 102, which is referred to in a main control process which will be described later.

In the symbol random determination table for the second reel, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in a symbol random determination table for the second reel shown in FIG. 28, “FIRE7” of the second reel 102 corresponding to the code number “0” is rearranged in the middle stage of the display window 150 (on the payline) at a probability of 10/147. “BLANK” of the second reel 102 corresponding to the code number “1” is rearranged in the middle stage of the display window 150 (on the payline) at a probability of 6/147. “RED7” of the second reel 102 corresponding to the code number “4” is rearranged in the middle stage of the display window 150 (on the payline) at a probability of 10/147.

(Symbol Random Determination Table for Third Reel)

Now, the symbol random determination table for the third reel will be described with reference to FIG. 29. In the present embodiment, the random determination table for the third reel is a random determination table defining probabilities of 22 symbols regarding the third reel 103, which is referred to in a third reel symbol random determination process of determining symbols of the third reel 103 to be rearranged in the middle stage (payline) of the display window 150 in the main control process which will be described later. There are three types of the symbol random determination tables for the third reel, namely Type A, Type B, and Type C. Which type of the symbol random determination table for the third reel, Type A, Type B, or Type C, is used is determined in the later-described third reel symbol random determination table selection process.

As shown in FIG. 29, in the Type-A symbol random determination table for the third reel, probabilities (WEIGHT) are set for 22 symbols corresponding to code numbers “0” to “21”, respectively. Each probability (WEIGHT) indicates a probability that the corresponding symbol 501 is rearranged in the middle stage (on the payline) of the display window 150. For example, in the Type-A symbol random determination table for the third reel shown in FIG. 29, “FIRE7” of the third reel 103 corresponding to the code number “0” is rearranged in the middle stage of the display window 150 (on the payline) at a probability of 1/117. “BLANK” of the third reel 103 corresponding to the code number “1” is rearranged in the middle stage of the display window 150 (on the payline) at a probability of 6/117. “RED7” of the third reel 103 corresponding to the code number “4” is rearranged in the middle stage of the display window 150 (on the payline) at a probability of 1/117.

As shown in FIG. 29, in the Type-B symbol random determination table for the third reel, probabilities (WEIGHT) are set for 22 symbols corresponding to code numbers “0” to “21”, respectively. For example, in the Type-B symbol random determination table for the third reel shown in FIG. 29, “FIRE7” of the third reel 103 corresponding to the code number “0” is rearranged in the middle stage of the display window 150 (on the payline) at a probability of 3/198. “BLANK” of the third reel 103 corresponding to the code number “1” is rearranged in the middle stage of the display window 150 (on the payline) at a probability of 3/198. “RED7” of the third reel 103 corresponding to the code number “3” is rearranged in the middle stage of the display window 150 (on the payline) at a probability of 3/198.

As shown in FIG. 29, in the Type-C symbol random determination table for the third reel, probabilities (WEIGHT) are set for 22 symbols corresponding to code numbers “0” to “21”, respectively. For example, in the Type-C symbol random determination table for the third reel shown in FIG. 29, “FIRE7” of the third reel 103 corresponding to the code number “0” is rearranged in the middle stage of the display window 150 (on the payline) at a probability of 10/162. “BLANK” of the third reel 103 corresponding to the code number “1” is rearranged in the middle stage of the display window 150 (on the payline) at a probability of 60/162. “RED7” of the third reel 103 corresponding to the code number “4” is rearranged in the middle stage of the display window 150 (on the payline) at a probability of 3/162.

(Symbol Random Determination Table Selection Table for Third Reel)

Now, the symbol random determination table selection table for the third reel will be described with reference to FIG. 30. The symbol random determination table selection table for the third reel is referred to in the third reel symbol random determination table selection process in the later-described main control process.

In this symbol random determination table selection table for the third reel, a combination of to-be-stopped symbols on the first reel 101 and the second reel 102 determined in a first reel symbol random determination process and a second reel symbol random determination process which will be described later is associated with one of the three types of tables, i.e., Type-A, Type-B, and Type-C symbol random determination tables for the third reel.

To be more specific, when the to-be-stopped symbol on the first reel 101 is “FIRE7” and the to-be-stopped symbol on the second reel 102 is “FIRE7”, the Type-C symbol random determination table for the third reel is associated. When the to-be-stopped symbol on the first reel 101 is “FIRE7” and the to-be-stopped symbol on the second reel 102 is “RED7”, the Type-B symbol random determination table for the third reel is associated. When the to-be-stopped symbol on the first reel 101 is “RED7” and the to-be-stopped symbol on the second reel 102 is “RED7”, the Type-B symbol random determination table for the third reel is associated. When a combination of the to-be-stopped symbols on the first reel 101 and the second reel 102 is none of the above, the Type-A symbol random determination table for the third reel is associated.

In the symbol random determination table selection table for the third reel above (see FIG. 29), the Type-B and Type-C symbol random determination tables for the third reel corresponding to symbol combinations including a symbol “FIRE7” or “RED7” (predetermined symbol) are arranged so that the probability of rearrangement of the symbol “FIRE7” or “RED7” (predetermined symbol) is higher than the probability in the Type-A symbol random determination table for the third reel corresponding to a combination of symbols not including the symbol “FIRE7” or “RED7” (predetermined symbol) (equivalent to other combinations shown in FIG. 29).

As such, when a combination of symbols rearranged on the first reel 101 and the second reel 102 includes “FIRE7” or “RED7”, the probability of rearrangement of “FIRE7” or “RED7” on the third reel 103 is increased, with the result that monotonous game play is avoided.

In the symbol random determination table selection table for the third reel above (see FIG. 29), the Type-B and Type-C symbol random determination tables for the third reel corresponding to symbol combinations including a symbol “FIRE7” or “RED7” (predetermined symbol) are arranged so that the probability of rearrangement of the symbol “FIRE7” or “RED7” in one of the display areas in the upper stage, the middle stage, and the lower stage of the display window 150 is higher than the probability in the Type-A symbol random determination table for the third reel corresponding to a combination of symbols not including the symbol “FIRE7” or “RED7” (predetermined symbol) (equivalent to other combinations shown in FIG. 29).

To be more specific, in the Type-A symbol random determination table for the third reel, the probability of rearrangement of the symbol “RED7” in one of the display areas in the upper stage, the middle stage, and the lower stage of the display window 150 corresponds to a case where a to-be-stopped symbol is a symbol corresponding to one of the code numbers “3”, “4”, “5”, “15”, “16”, and “17”, and is equal to (6/117)+(1/117)+(61117)+(61117)+(11117)+(61117)=26/117. In the meanwhile, in the Type-B symbol random determination table for the third reel, the probability of rearrangement of the symbol “RED7” in one of the display areas in the upper stage, the middle stage, and the lower stage of the display window 150 corresponds to a case where a to-be-stopped symbol is a symbol corresponding to one of the code numbers “3”, “4”, “5”, “15”, “16”, and “17”, and is equal to (30/198)+(3/198)+(30/198)+(30/198)+(3/198)+(30/198)=126/198. As such, the Type-B symbol random determination table for the third reel is arranged such that the probability of rearrangement of the symbol “RED7” in one of the display areas in the upper stage, the middle stage, and the lower stage of the display window 150 is higher than the probability in the Type-A symbol random determination table for the third reel.

In the Type-A symbol random determination table for the third reel, the probability of rearrangement of the symbol “FIRE7” in one of the display areas in the upper stage, the middle stage, and the lower stage of the display window 150 corresponds to a case where a to-be-stopped symbol is a symbol corresponding to one of the code numbers “21”, “0”, and “1”, and is equal to (6/117)+(1/117)+(6/117)=13/117. In the Type-C symbol random determination table for the third reel, the probability of rearrangement of the symbol “FIRE7” in one of the display areas in the upper stage, the middle stage, and the lower stage of the display window 150 corresponds to a case where a to-be-stopped symbol is a symbol corresponding to one of the code numbers “21”, “0”, and “1”, and is equal to (60/162)+(10/162)+(60/162)=130/162. As such, the Type-C symbol random determination table for the third reel is arranged such that the probability of rearrangement of the symbol “FIRE7” in one of the display areas in the upper stage, the middle stage, and the lower stage of the display window 150 is higher than the probability in the Type-A symbol random determination table for the third reel.

According to the arrangement above, when a combination of symbols rearranged on the first reel 101 and the second reel 102 includes “FIRE7” or “RED7”, “FIRE7” or “RED7” is more likely to be rearranged in the display area in the upper stage, the middle stage, or the lower stage of the display window 150, in regard to the symbol rearranged on the third reel 103. Because “FIRE7” or “RED7” is more likely to be rearranged in the display area in the upper stage, the middle stage, or the lower stage of the display window 150, monotonous game play is avoided.

[Contents of Program]

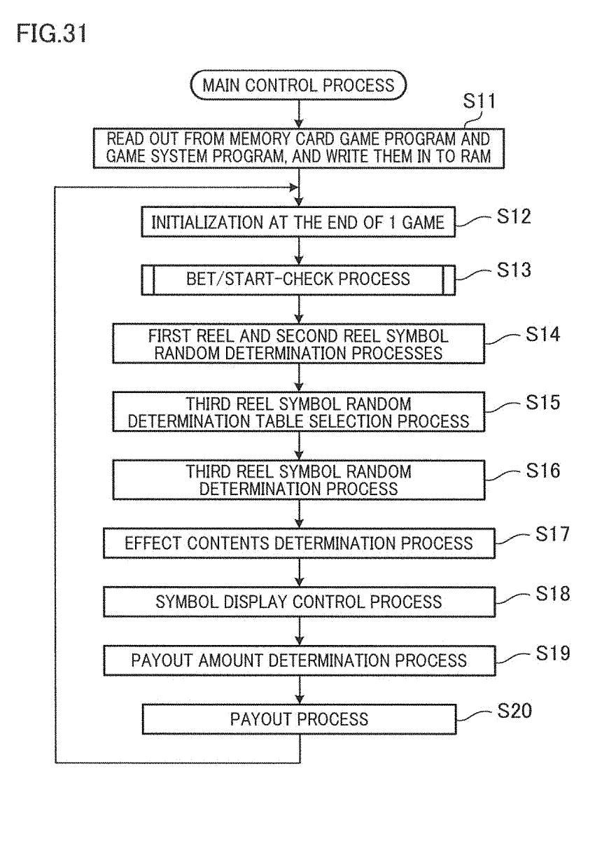

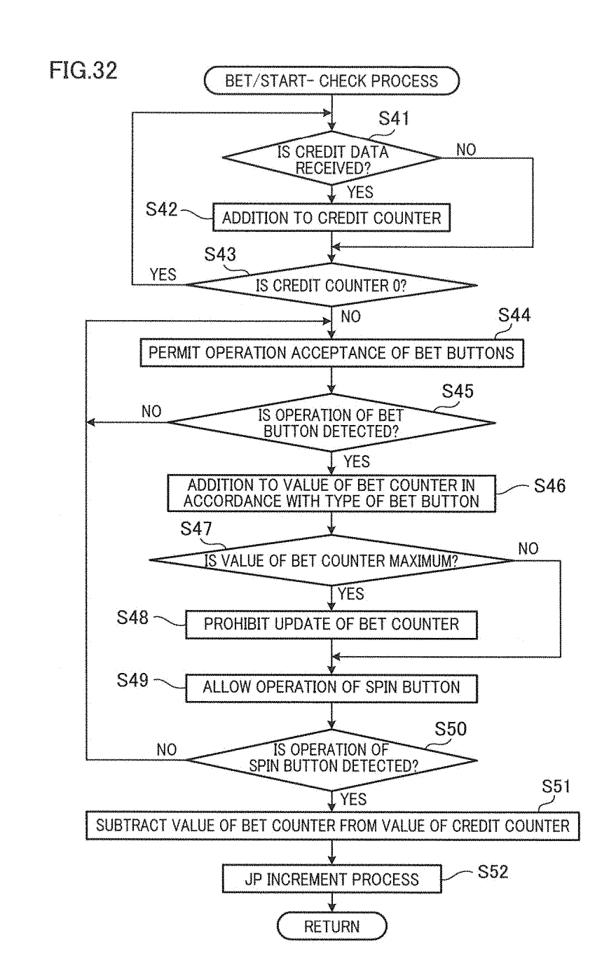

Now, the program to be executed by the slot machine 1 is described with reference to FIG. 31 and FIG. 32.

(Main Control Process)

Referring to FIG. 31, a main control process will be described. In the main control process, a slot game is executed.

First, when the slot machine 1 is powered on, the main CPU 71 reads an authenticated game program and a game system program from a memory card 54 via a gaming board 50, and then write them in the RAM 73 (S11).

Subsequently, the main CPU 71 executes an initializing process at the end of each play of the game, in order to start the slot game (S12). This process clears data in a working area of the RAM 73, which becomes unnecessary at the end of each play of the slot game, e.g., the bet amount, symbols randomly determined, and the like.

The main CPU 71 then executes a later-described bet/start-check process (S13). In this process, an input check or the like is executed for switches such as the 1-BET switch 34S, the 2-BET switch 35S, the 3-BET switch 36S, and the spin switch 46S.

Then, the main CPU 71 executes a first reel and second reel symbol random determination processes (equivalent to the first symbol random determination process) (S14). In the first and second reel symbol random determination processes, based on the probability (WEIGHT) defined in the symbol random determination table for the first reel (see FIG. 27), one to-be-stopped symbol to be rearranged in the middle stage (on the payline) of the display window 150 in regard to the first reel 101 is randomly determined, and based on the probability (WEIGHT) defined in the symbol random determination table for the second reel (see FIG. 28), one to-be-stopped symbol to be rearranged in the middle stage (on the payline) of the display window 150 in regard to the second reel 102 is randomly determined.

For example, when the code number “0” is selected at the random determination probability of 4/71 for the first reel 101, “RED7” corresponding to the code number “0” of the first reel 101 is selected as a to-be-stopped symbol to be rearranged in the middle stage of the display window 150 (on the payline). When the code number “0” is selected at the random determination probability of 10/147 for the second reel 102, “FIRE7” corresponding to the code number “0” of the second reel 102 is selected as a to-be-stopped symbol to be rearranged in the middle stage of the display window 150 (on the payline).

The main CPU 71 stores the determined to-be-stopped symbols of the first reel 101 and the second reel 102 in the symbol storing area in the RAM 73.

Then, the main CPU 71 executes a third reel symbol random determination table selection process (S15). In this third reel symbol random determination table selection process, Type (Type A, Type B, or Type C) of the symbol random determination table for the third reel, which is referred to when a later-described third reel symbol random determination process (S16) is executed, is selected with reference to a combination of to-be-stopped symbols on the first reel 101 and the second reel 102 determined in the first reel and second reel symbol random determination processes in S14 and the symbol random determination table selection table for the third reel (see FIG. 30). The information of the selected Type of the symbol random determination table for the third reel is stored in the RAM 73.

For example, when the to-be-stopped symbol on the first reel 101 is “FIRE7” and the to-be-stopped symbol on the second reel 102 is “FIRE7” as a result of the first reel and second reel symbol random determination processes in S14, the symbol random determination table selection table for the third reel (see FIG. 30) is referred to and the corresponding Type-C symbol random determination table for the third reel is selected.

Then, the main CPU 71 executes a third reel symbol random determination process (equivalent to the second reel symbol random determination process) (S16). In this third reel symbol random determination process, based on the probability (WEIGHT) defined by the Type (Type A, Type B, or Type C) (see FIG. 29) of the symbol random determination table for the third reel selected in the third reel symbol random determination table selection process in S15, one to-be-stopped symbol to be rearranged in the middle stage (on the payline) of the display window 150 in regard to the third reel 103 is randomly determined.

For example, when the Type of the symbol random determination table for the third reel selected in the third reel symbol random determination table selection process in S15 is Type C, the Type-C symbol random determination table for the third reel shown in FIG. 29 is referred to. When the code number “0” is selected at the random determination probability of 10/162 for the third reel 103, “FIRE7” corresponding to the code number “0” of the third reel 103 is selected as a to-be-stopped symbol to be rearranged in the middle stage of the display window 150 (on the payline).

The main CPU 71 stores the determined to-be-stopped symbol of the third reel 103 in the symbol storing area in the RAM 73.

Then, the main CPU 71 executes an effect contents determination process (S17). The main CPU 71 extracts an effect-use random number and randomly selects one of a plurality of predetermined effect contents.

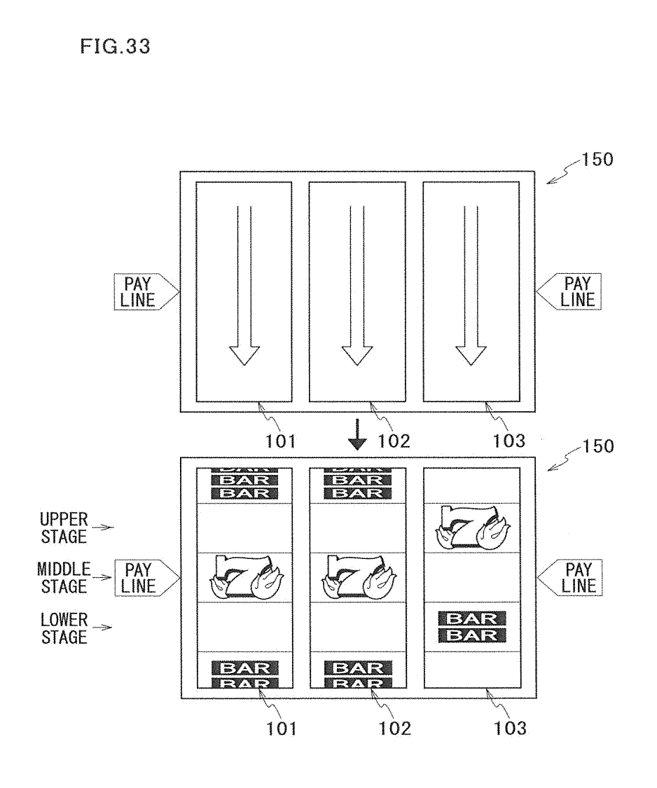

Then, the main CPU 71 executes a symbol display control process (S18). In this symbol display control process, as shown in FIG. 33, the scroll of the first reel 101, the second reel 102, and the third reel 103 starts, and after a predetermined time elapses, the to-be-stopped symbol in regard to the first reel 101 selected in the first reel and second reel symbol random determination processes in S14 is rearranged in the middle stage of the display window 150 (on the payline). Subsequently, in regard to the second reel 102, the to-be-stopped symbol determined in the first reel and second reel symbol random determination processes in S14 is rearranged in the middle stage of the display window 150 (on the payline). Furthermore, in regard to the third reel 103, the to-be-stopped symbol determined in the third reel symbol random determination process in S16 is rearranged in the middle stage of the display window 150 (on the payline). As such, the to-be-stopped symbols corresponding to the first reel 101 to third reel 103 stop one by one in the middle stage of the display window 150 (on the payline). That is, 9 symbols including the to-be-stopped symbols are displayed in the display window 150 (in the upper stage, the middle stage, and the lower stage). For example, when the to-be-stopped symbol on the first reel 101 is “FIRE7”, the to-be-stopped symbol on the second reel 102 is “FIRE7”, and the to-be-stopped symbol on the third reel 103 is “BLANK”, “FIRE7”, “FIRE7”, and “BLANK” are rearranged in the middle stage of the display window 150 (on the payline) as shown in FIG. 33.

Then, the main CPU 71 executes a payout amount determination process (S19). In this process, payout is determined based on a symbol combination displayed on the payline with reference to the symbol combination table (see FIG. 26) stored in the RAM 73 and the value (1BET, 2BET, or 3BET) of the bet counter, and the payout is stored in the payout amount storage area provided in the RAM 73. For example, when the value of the bet counter is “3” and the symbol combination displayed on the payline is three “3BAR”, “60” credits are determined as the payout with reference to the symbol combination table shown in FIG. 26 and stored in the payout amount storage area in the RAM 73.

When the value of the bet counter is “3” (MAXBET) and the symbol combination displayed on the payline is three “FIRE7”, progressive payout is awarded. To be more specific, the value of a progressive payout counter (described later) stored in the RAM 73 is awarded as the progressive payout. The value of the progressive payout counter is calculated in such a way that, in a later-described JP increment process in S52, a value calculated by multiplying the value of the bet counter by an increment rate (0.01) is accumulatively added to the initial value of 1000 in each game play. When the progressive payout is won, the value of the progressive payout counter is stored in the payout amount storage area of the RAM 73. Furthermore, when the progressive payout is won, a message which notifies that the progressive payout has been awarded is displayed. To be more specific, messages “CONGRATULATIONS !”, “PROGRESSIVE WIN”, and “XXXXXXXX CREDITS” are displayed on the upper image display panel 131.

Then a payout process is executed (S20). The main CPU 71 adds the value stored in the payout amount storage area to the value of the credit counter in the RAM 73. The routine then proceeds to S12.

(Bet/Start-Check Process)

Now the bet/start-check process will be described with reference to FIG. 32.

To begin with, the main CPU 71 determines whether credit data has been received from the PTS device 700 (S41). The credit data is sent from the PTS device 700 to the main CPU 71, for example, when the IC card is inserted into the card insertion slot and when the bill entry 60 receives a genuine bill.

When the credit data is received (S41: YES), the main CPU 71 adds the amount indicated by the received credit data to the value of the credit counter (S42).

After the step S42 or when determining in S41 that no credit data is received (S41: NO), the main CPU 71 determines whether or not the value stored in the credit counter is 0 (S43). When determining that the value of the credit counter is 0 (S43: YES), the main CPU 71 goes back to S41.

When the main CPU 71 determines that the value of the credit counter is not 0 (S43: NO), the main CPU 71 permits operation acceptance of the BET buttons (1-BET button 34, 2-BET button 35, and 3-BET button 36) (S44).

Then the main CPU 71 determines whether an operation of the BET button is detected (S45). When an operation of the bet button by a player is detected by the bet switch (1-BET switch 34S, 2-BET switch 35S, or 3-BET switch 36S), the main CPU 71 performs addition to the value of the bet counter in the RAM 73, based on the type of the BET button (S46).

Subsequently, the main CPU 71 determines whether the value of the bet counter is at the maximum (S47). When determining that the value of the bet counter is at the maximum (S47: YES), the main CPU 71 prohibits the update of the value of the bet counter (S48). After S48, when determining in S47 that the value of the bet counter is not at the maximum (S47: NO), the main CPU 71 enables operation of the spin button 46 (S49).

After S49, the main CPU 71 determines whether an operation of the spin button 46 is detected (S50). When the main CPU 71 determines that an operation of the spin button 46 is not detected (S50: NO), the routine proceeds to S41.

In the meanwhile, when the main CPU 71 determines that operation of the spin button 46 is detected (S50: YES), the main CPU 71 subtracts the value of the bet counter calculated in S46 from the value of the credit counter (S51).

The main CPU 71 then executes a JP increment process (S52). In the JP increment process, as the resource of the progressive payout, the value of the progressive payout counter in the RAM 73 is incremented by a value calculated by multiplying the value of the bet counter calculated in S46 by an increment rate (0.01 but may be optionally set) set in the present embodiment. For example, when the value of the bet counter calculated in S46 is “3”, 3×0.01=0.03 credit is added to the value of the progressive payout counter. In the present embodiment, the initial value of the progressive payout counter is 1000 credits. Therefore, in the progressive payout counter, a value calculated by multiplying the value of the bet counter by the increment rate (0.01) is accumulatively added to the initial value of 1000 in each game play.

Then the bet/start-check process is terminated.

According to the arrangement above, based on a combination of symbols rearranged on the first reel 101 and the second reel 102, Type of the symbol random determination table for the third reel, which is referred to when a symbol rearranged on the third reel 103 is randomly determined, is selected. According to this, the probability of rearrangement of the symbol on the third reel 103 is changeable in association with a combination of symbols rearranged on the first reel 101 and the second reel 102, with the result that monotonous game play is avoided.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine comprising:
a display device configured to display symbols by rearranging reels on which symbols are arranged;
a storage device configured to store symbol random determination tables in which the probabilities of rearrangement of a predetermined symbol are differentiated between reels by defining the probability of rearrangement of each symbol and a symbol random determination table selection table in which combinations of rearranged symbols are associated with the symbol random determination tables; and
a controller programmed to execute:
(1A) a symbol random determination process of randomly selecting a symbol to be rearranged from symbols on a predetermined reel, based on a predetermined symbol random determination table;
(1B) a process of selecting one of the symbol random determination tables, with reference to the symbol selected in the symbol random determination process and the symbol random determination table selection table; and
(1C) a symbol random determination process of randomly selecting a symbol to be rearranged from symbols on a reel which is to be rearranged after the predetermined reel, based on the symbol random determination table selected in the process (1B).

2. The gaming machine according to claim 1, wherein,
the controller is configured to further execute:
(1D) a process of repeating the processes (1B) and (1C) until symbols to be rearranged on all reels are determined; and
(1E) a process of displaying the symbols to be rearranged on each of the reels on the display device, by rearranging the reels.

3. The gaming machine according to claim 1, wherein,
in the symbol random determination table selection table, a symbol random determination table corresponding to the predetermined symbol is arranged so that the probability of rearrangement of the predetermined symbol is higher than the probability of rearrangement of the predetermined symbol in a symbol random determination table corresponding to another symbol.

4. The gaming machine according to claim 1, wherein,
when the predetermined symbol is selected as a symbol to be rearranged in the symbol random determination process (1A), the symbol random determination table selection table in which the probability of rearrangement of the predetermined symbol in the symbol random determination table corresponding to the predetermined symbol is higher than the probability of rearrangement of the predetermined symbol in a symbol random determination table corresponding to another symbol is referred to in the process (1B).

5. A gaming machine comprising:
a display device configured to display symbols by rearranging reels on which symbols are arranged;
a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
a process of selecting, from the symbol random determination tables, a symbol random determination table which is referred to in a symbol random determination process of selecting a symbol to be rearranged from symbols on an N-th reel to be rearranged (N is an integer 3 or larger), with reference to a combination of symbols which are rearranged on reels which are fewer in number than N and rearranged before the N-th reel and with reference to the symbol random determination table selection table; and
a symbol random determination process of, based on the symbol random determination table selected in the preceding process, randomly selecting a symbol from the symbols on the N-th reel to be rearranged.

6. A gaming machine comprising:
a display device configured to display a game result by rearranging N (N is three or larger integers) reels on which symbols are arranged;
a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
(1A) a first symbol random determination process of, when a game starts, based on a predetermined symbol random determination table, randomly selecting each symbol to be rearranged from symbols on first to (N−1)-th reels to be rearranged;
(1B) a process of selecting one of the symbol random determination tables with reference to a combination of the symbols selected in the first symbol random determination process and the symbol random determination table selection table;
(1C) a second symbol random determination process of randomly selecting a symbol to be rearranged from symbols on the N-th reel to be rearranged, based on the symbol random determination table selected in the process (1B); and
(1D) a process of displaying the symbols selected in the first symbol random determination process and the second symbol random determination process by rearranging the first to N-th reels to be rearranged.

7. The gaming machine according to claim 6, wherein,
in the symbol random determination table selection table, a symbol random determination table corresponding to a combination of symbols including the predetermined symbol defines that the probability of rearrangement of the predetermined symbol is higher than the probability in a symbol random determination table corresponding to a combination of symbols not including the predetermined symbol.

8. The gaming machine according to claim 6, wherein,
when a combination of the symbols determined in the first symbol random determination process in (1A) is a combination of symbols including the predetermined symbol, in the process (1B), the symbol random determination table selection table in which the probability of rearrangement of the predetermined symbol in the symbol random determination table corresponding to a combination of symbols including the predetermined symbol is higher than the probability of rearrangement of the predetermined symbol in the symbol random determination table corresponding to a combination of symbols not including the predetermined symbol is selected.

9. The gaming machine according to claim 6, wherein,
the display displays a game result by a combination of symbols formed by rearranging N (N is 3 or larger) reels, on which symbols are provided, in a matrix-shaped display areas, and
in the symbol random determination table selection table, a symbol random determination table corresponding to a combination of symbols including the predetermined symbol is a symbol random determination table which defines that the probability of rearrangement of the predetermined symbol in a predetermined display area is higher than the probability in a symbol random determination table corresponding to a combination of symbols not including the predetermined symbol.

10. A gaming machine comprising:
a display device configured to display symbols by rearranging reels on which symbols are arranged;
a storage device configured to store symbol random determination tables in which the probabilities of rearrangement of a predetermined symbol are differentiated by defining the probability of rearrangement of each symbol and a symbol random determination table selection table in which combinations of rearranged symbols are associated with the symbol random determination tables; and
a controller programmed to execute:
a process of selecting, from the symbol random determination tables, a symbol random determination table which is referred to in a symbol random determination process of selecting a symbol to be rearranged from symbols on a predetermined-number-th reel to be rearranged, with reference to a combination of symbols rearranged on the first to ((predetermined number)−1)-th reels and the symbol random determination table selection table; and
a symbol random determination process of, based on the symbol random determination table selected in the process above, randomly selecting a symbol to be rearranged, from the symbols on the predetermined-number-th reel to be rearranged.
